(19) United States
(12) Patent Application Publication
(10) Pub. No.: US 2010/0070351 A1
(43) Pub. Date: Mar. 18, 2010

(54) ELECTRONIC ADVERTISEMENT METHOD AND SYSTEM USING ADVERTISEMENT INTERMEDIATION SITE

(76) Inventor: Dong Kyun Kang, Seoul (KR)

Correspondence Address: THE NATH LAW GROUP, 112 South West Street, Alexandria, VA, 22314, US

(21) Appl. No.: 12/448,114

(22) PCT Filed: Apr. 14, 2008
(86) PCT No.: PCT/KR2008/002104

§ 371 Date: Jun. 9, 2009

(30) Foreign Application Priority Data
Apr. 13, 2007 (KR) 10-2007-0036558
Apr. 10, 2008 (KR) 10-2008-0033013

(51) Int. Cl. G06Q 30/00; G06F 17/00; H04L 9/32; G06F 3/048

(52) U.S. Cl. 705/14.1; 705/14.45; 715/234; 726/4; 715/748

(57) ABSTRACT

The present invention is related to an electronic advertisement method using an advertisement intermediation site, comprising: registering an electronic ad of a sponsor with an adidentifier of the electronic ad on the advertisement intermediation site; distributing the registered electronic ad to a text writing area of other site with attaching a distributoridentifier when a distributor member distributes the registered electronic ad to said other site including at least one text writing area; monitoring distribution status, exposure number and click number of the distributed electronic ad using the adidentifier and the distributoridentifier so as to calculate an advertising result; and rewarding the distributor member with a portion of an advertising cost paid by the sponsor as a first advertising fee based on the advertising result of the distributor member. According to the present invention, anybody using the network environment regardless of owning a site can distribute electronic ads to arbitrary sites that allow the text writing so as to positively participate in advertising and take a reward for the distribution activity.

### TECHNICAL FIELD

The present disclosure relates to an electronic advertisement method and system using an advertisement intermediation site; and, more particularly, to an advertisement method and system that enable any members of the advertisement intermediation site to distribute the electronic ads registered on the advertisement intermediation site to any sites existing in a network and to get rewards for their ad-distributing actions. Furthermore, the present disclosure relates to an electronic advertisement method and system that enables general network users to easily distribute the electronic ads from the advertisement intermediation site to a partner site and also achieve contextual advertisement.

### BACKGROUND ART

As the network infra including internet or wireless communication is constructed, the cyber-spaces provided in the network are utilized for various purposes such as shoppingmall, game, community, information management and etc, and the range of these utilizations is gradually expanding corresponding to the development of the network technology and the wide spread of personal terminal with wire or wireless communication function, good performance and cheap price.

According to the above-described tendency, the advertisement put in a cyber-space provides almost the same or sometimes more advertisement power in comparison with the broadcast advertising made in Radio and TV or the outdoor advertising made in the building structure, and thus the electronics ads provided to the network user via PC or portable terminals such as cellular phone and PDA (Personal Digital Assistant) are becoming an important meal ticket for a wire/wireless search or portal site.

With regard to this, various business models that enable the distribution of the sponsor's ads on the internet are proposed, and the Korean Patent Publication 2001-0067802 (hereinafter, “Priorart1”) is one example of those models.

Priorart1 relates to an electronic advertisement method using personal homepages and suggests an idea that derives unconscious advertising effect by bulletining the ads on a plurality of personal homepages. More specifically, the advertisement method according to Priorart1 includes: a step for a consumer selecting an ad bulletined on a member's homepage and visits to a site linked with the ad at the same time with the ad selection; a step for the consumer inputting purchase information including a price and a payment method for a purchased product on the visited site and settling with the purchased product; a step that an advertisement intermediation site calculating a discount rate for the member's homepage according to the purchase information and transmits the discount rate information to the member; and a step for reflecting the discount rate to the price of a product advertised on the member's homepage according to the discount rate information.

However, Priorart1 has a limitation in that the only member who can bulletin ads so as to get a discount rate is the one who owns a personal homepage. On the internet, there may exist □) portal site managers who provide personal homepage or blog, □) individuals who own personal homepage provided by portal sites as members of the portal site, and □) a plurality of general visitors who visit the personal homepages, and thus it is apparent that the number of the general visitors is the largest among these three groups. Therefore, Priorart1, which only allows the personal homepage owner to bulletin the ads so as to get an income, treats the largest group (that is, general visitors) as a mere advertising object instead of advertising subject. This may be a serious problem since the electronic ads, which should be distributed as much as possible so as to maximize the advertisement effect, can only be distributed by a small number of personal homepage owners. Moreover, if the personal homepage of Priorart1 is provided by the portal site, using the advertising method of Priorart1 to make a personal profit may be a violation of the portal's management policy which prohibits member's profit-making using the portal's blog or homepage, and in this case advertising action on personal homepages such as blogs may be blocked by the portal site manager.

In the meantime, there is also suggested another business model of distributing sponsor's ads on the interne using an advertisement brokering host, and an example of which is PCT publication WO2001/037158 (hereinafter, “Priorart2”).

Priorart2 suggests an electronic advertisement method using the advertisement brokering host for brokering a plurality of interne ads between an advertiser (that is, a sponsor) and an individual website operator via the interne. The host according to Priorart2 includes a database for storing each internet advertisement identifier that corresponds to each internet advertisement and data on the effectiveness of an interne advertisement. The advertisement brokering host provides a webpage for publishing internet ads and corresponding advertisement guide information so that a website operator is allowed to take internet ads onto his or her website. A website operator or a publisher can receive an advertisement income with respect to data on the effectiveness of all internet ads which have been displayed on his or her website irrespective of advertisers. Also, advertisers can pay charges for advertising services irrespective of publishers taking and loading ads onto their websites.

According to Priorart2, a publisher who has a small number of visitors is allowed to load ads without receiving the approval of an advertiser. As a result, small-scale advertisement is encouraged. In addition, since an advertisement fee can be calculated in an advertisement brokering host, a number of advertisers and publishers can engage in advertising activity at their desire.

However, in Priorart2, the person who can load ads from the advertisement brokering host, or the electronic ads distributor should be a website manager so that a person who does not manage or own a website is unable to participate in the electronic advertisement method disclosed in Priorart2, and this in turn may be the reason for the limited distribution in consideration of the fact that the number of website managers is extremely small in comparison with the number of total internet users.

Furthermore, Priorart2 does not give any solution for obtaining internet ads except the sponsor's voluntary ads although the variety and quantity of the internet ads should be secured for the revitalization of the advertisement brokering site. Also, the electronic ads distributed by the website owner according to Priorart2 are subject to be recognized as a pure advertisement by a website user and this may result in internet user's refusal reaction and thus a negative influence upon the click-rate of the distributed ads.

On the other hand, the electronic advertising of the prior art has been done by installing banner or pop-up ads on some part of the screen in a portal site and exposing them to the internet user, but this kind of electronic advertisement has the following problems:

□) At first, it cannot be expected to distribute a lot of electronic ads on a huge number of network pages comprising various and enormous contents in the electronic advertisement method according to the prior art. The electronic ads need to be distributed as many and various pages as possible so as to obtain a satisfactory electronic advertisement result, but the banner ads or pop-up ads are limitedly executed on a predetermined website page and predetermined position designated by the website owner who made an advertisement contract with the sponsor so that it cannot be expected for the electronic ads to be distributed on various and many web pages. Of course, for example, it may be possible for a portal site that supports personal blogs to insert banner or hyperlink-type ads not only on the portal's main page but also on some part of the personal blogs, but this may confront with another issue that blog ads forced by the portal site needs to be minimized to guarantee the independence of the personal blogs.

□) Secondly, in the conventional electronic advertisement method, the network user is forced to be exposed to a predetermined electronic ad so that the ad is subject to be treated as an obstacle that disturbs network surfing instead of useful information, and endlessly pop-up ads on every page visited are sometimes the cause for increasing the load in both the user terminal and the network server especially when the speed of the network circuit used by the network user is slow. □) Also, since the conventional electronic advertisement method mechanically and regimentally provides ads regardless of the network user's purpose who visits a site, there is a limitation in achieving the contextual advertisement that considers the web user's intent of web browsing. In fact, although a number of ads that can be seen in the present website are mostly not related with the webpage's text content at all, sponsors are spending enormous advertisement cost to display their ads on the pages of portal sites.

□) Furthermore, in the conventional electronic advertisement method, even though the network environment has a characteristics that enables relatively easy interactive communication between the site owner and the site visitor compared to the outdoor advertising or broadcast advertising, said interactive characteristics cannot be fully utilized since the network site exposes one-sided ads to the user who visited its page only after the network site completes the contract with sponsors just like outdoor advertising or broadcast advertising. In other words, although the true subject that creates and consumes information on the network is the network user, the network user who provides advertising foundation is merely treated as an exposure object of advertisements.

To overcome the above-mentioned problems of the conventional electronic advertisement method, other types of electronic advertisement method are suggested, and an example of which is Korean Patent Publication 2003-0091085 (hereinafter, “Priorart3”) that relates to an internet advertising exposed on the background of webpage according to mouse activity over text keyword, and a rough structure thereof is shown in FIG. 1.

Priorart3 proposes an electronic advertisement method that continuously shows an ad-content on the background screen of a webpage when a web user put his or her mouse near a specific text keyword of the webpage. According to Priorart3, an electronic ad is exposed only when a user approaches the mouse near a specific keyword unlike the conventional banner or pop-up advertising and thus a user may highly focus and recognize an electronic ad and this may in turn raise the possibility of user's ad-click. Also, Priorart3 may be modified to maintain the ad-image on the background screen even after the user clicks a specific keyword of the webpage to move to another webpage and thereby an advertising effect may be continued even when the web user is not using the webpage any more.

However, in the electronic advertisement method according to Priorart3, the ad is still mechanically and regimentally provided to the web user accessing the web server 21 based on the coupling relationship between ad-content and text keyword that are designated only by the sponsor 10 and the website 20 manager, respectively. Therefore, the predetermined keyword may only execute a regimental and mechanical advertisement regarding the predetermined electronic ad so far as the coupling relationship between the ad-content and the text keyword does not change. For example, assuming that a keyword “apple” has been designated to advertise a computer product manufactured by American Company APPLE, then the keyword “apple” can only mechanically output computer-related advertisement even in the web pages which deal with fruit sale such as apple or the educational web pages which are designed to teach the meaning of English word, apple. In consideration of this assumption, it cannot be said that the advertising method suggested by Priorart3 overcame the mechanical and regimental problem of the conventional advertisement method.

Moreover, since a person who may create a tag type linkage between the electronic ad and the text content existing in network webpage is eventually the owner who manages the website that contains the network webpage, Priorart3 is inefficient in that a manager should create each linkage on every single word existing in his or her numerous web pages.

In addition, since the electronic ads are distributed based on the mechanical keyword base, it is hard to distribute electronic ads to various and many web pages provided by the web server (21) so that satisfactory advertising result cannot be expected especially in a case that keywords that will be linked with ads are exhausted, or keywords with sponsor's preference has been already occupied by other sponsor, or the sponsor 10 selects rarely used keyword. As can be easily seen in FIG. 1, the only advertising subjects are the sponsor 10 and the website manager 20 in the electronic advertisement method of Priorart3, and the web user 30 is still only treated as an exposure object of the electronic ads.

In the meantime, there are also suggested electronic advertisement methods that improved the advertisement participation degree of the web user in comparison with the electronic advertisement method shown in FIG. 1, one of which is Korean Patent Publication 2005-0086104 (hereinafter, “Priorart4”) relating with a system and method of profit sharing by bulletin board including advertisements chosen by authors and the other of which is Korean Patent Publication 2004-0071786 (hereinafter, “Priorart5”) relating with a user based advertising method on internet boards and cyber-space where multi-users make contact and watch. FIG. 2 schematically shows the electronic advertisement system disclosed in Priorart4 and Priorart5.

Priorart4 is an invention regarding a method to share a profit obtained by exposing both the advertisement and the content to the reader with the content maker selecting the advertisement in consideration of the content's characteristics. That is, Priorart4 is aimed to maximize the access number versus exposure number of the electronic ads by letting the content maker select the ads considering the reader's propensity. More specifically, the electronic advertisement method according to Priorart4 is comprised of the following steps: collecting, storing, distributing and managing ads that will be included in a bulletin board; providing the ads to the content maker for advertisement selection; making the content maker bulletin the board with the provided ad that corresponds to the text character; exposing the ad when the reader accesses the content; inputting the data about the substance of the exposed ad to the sponsor company's database and the advertisement exposure management database; and distributing the profit to the content maker on the basis of the inputted data.

Also, Priorart5 relates to an advertising method in a cyber-space such as an internet board in which a multitude can access information. More specifically, Priorart5 includes the following steps: a first step of user's member subscripting and logging-in at a system comprised of a user computer, a main site and server that perform member management, advertisement storage, advertisement transmittance and reward, and a company that wants to advertise; a second step of contracting an advertisement and determining the content and process of the advertisement; a third step of accessing a cyber-space such as a bulletin in which a multitude can contact and watch and uploading an information including text writing; a forth step of storing the ad and the uploaded information by the user together in the main server; a fifth step of displaying the information attached with the ad when a user accesses the bulletin board; and a sixth step of executing verification and reward for the user's advertising. The electronic advertisement method according to Priorart5 is a method to provide a web user with a motivation for the advertising by a reward like Priorart2 and adopts the way to allow a web user to participate in advertising by letting the writer bulletin both the board content and the electronic ads.

However, the electronic advertisement methods according to Priorart4 and Priorart5 are limited in distributing the electronic ads to a number of various pages. Of course, in Priorart4 and Priorart5, the member 60 of the site 50 bulletins a text with an ad instead of the manager of the website 50 provided by the web server 4 interacting with DB server 51 and settlement server 53, and thus more satisfactory distribution result than the banner or pop-up advertising may be expected when there are a lot of members 60 who want to take rewards from the advertising bulletined with the text. However, since the member 60 of the website 50 needs to write a bulletin board to upload an electronic ad, a member 60 who is unwilling or indifferent to text writing may feel a burden of writing a bulletin board to participate in advertising, and thereby there may be still a limitation in distributing the electronic ads to a number of various bulletin boards.

Furthermore, in a case that the member 60 of website 50 should take a role for both ad-distributor and bulletin-writer, the quality of bulletin boards written in the website 50 is inevitably subject to decrease in consideration of the point that a member 60 pursuing a profit from participation in advertising may not want to spend much time on writing bulletin boards just for the advertisement. That is, the high degree of the correlation between ads and bulletin boards cannot be expected even according to the electronic advertisement methods of Priorart4 and Priorart5.

Also, if only the writer 60 judges the correlation between the bulletin board and the advertisement in advertising and links an ad with the bulletin board only based on his or her own personal thought, the advertisement may be far from the interest of the web user 70 reading the bulletin board. Although the advertisement may be functioning as a kind of information more than a mere advertisement if it corresponds to the network user's concern, an advertisement only performed based on the advertisement knowledge of bulletin writer 60 may confine the expectable information value of the advertisement.

Especially, since the web user 70 previously determines the content of the advertisement when subscribing a membership in the website 50 that will display the distributed advertisement and bulletin board and only the advertisement content determined at the time of subscribing is attached to every text written by the same web user 70 in the website 50 in the shape of ID or avatar in Priorart3, Priorart3 is actually irrelevant to contextual advertising.

### DISCLOSURE OF INVENTION

### Technical Problem

To solve the above-mentioned problems of prior arts, the present invention is aimed to provide an electronic advertisement method using an advertisement intermediation site that may revitalize the electronic advertisement by making any users using a network environment be able to distribute electronic ads to any sites so as to take rewards for the distribution activity.

The present invention is also aimed to provide electronic advertisement method that may maximize advertisement result by achieving contextual advertisement with unspecific multiple users in a network still being able to distribute ads easily to other site via the electronic intermediation site.

Moreover, the present invention is aimed to provide an electronic advertisement method to strengthen the base for contextual advertisement by utilizing electronic bulletin pages of a partner site in distributing electronic ads.

Furthermore, the present invention is aimed to provide an electronic advertisement method that may revitalize electronic advertisement by making the advertisement intermediation site obtain and secure enough electronic ads which will be intermediated for advertising.

Also, the present invention is aimed to embody and provide an electronic advertisement system for executing said electronic advertisement methods.

### Technical Solution

In accordance with the first aspect of the present invention, there is provided an electronic advertisement method using an advertisement intermediation site, comprising: registering an electronic ad of a sponsor with an ad-identifier of the electronic ad on the advertisement intermediation site; distributing the registered electronic ad to a text writing area of other site with attaching a distributor-identifier when a distributor member distributes the registered electronic ad to said other site including at least one text writing area; monitoring distribution status, exposure number and click number of the distributed electronic ad using the ad-identifier and the distributor-identifier so as to calculate an advertising result; and rewarding the distributor member with a portion of an advertising cost paid by the sponsor as a first advertising fee based on the advertising result of the distributor member.

That is, in the electronic advertising method according to the first aspect of the present invention, it is possible for any user of network environment such as wireless mobile communication to distribute the electronic ads registered in the advertisement intermediation site to any site as far as the site includes text writing area. In this way, the electronic advertising through the network may be revitalized since the sponsor may have a satisfactory advertising result and the distributor member may have an income with advertising activity. Basically the present invention is considering the point that the distribution of electronic ads cannot be activated if the distributor of electronic ads is confined to a website manager and it is very ineffective to treat the numerous internet users as a mere advertising object in the advertising intermediation. That is, the present invention makes it possible to insert electronic ads into the text writing area existing in the network site and thus makes it also possible for general internet users besides the owners or managers of websites to distribute electronic ads to other sites where the general web users do not have management authority and to make an income by the distribution activity.

In relation to the above-described prior arts, the first aspect of the present invention is differentiated with the prior arts by the following reason.

That is, in the present invention, the distribution of electronic ads occurs with the attachment of “distributor-identifier” to the distributed electronic ads in addition to the ad-identifier unlike the prior arts. Here, “distributor-identifier” is a unique identifier provided to a member who executed the distribution process of electronic ads among the members of the advertisement intermediation site, and acts a role just like a marker attached to the distributed electronic ads for the purpose of connecting the distribution activity of a member of the advertisement intermediation site with the management and reward of the distributed electronic ads. Therefore, the adoption of the distributor-identifier in addition to the ad-identifier in the present invention has an important technical meaning in that the advertisement intermediation site guarantees a definite reward to the member who distributed the electronic ads by administrating distribution, management and reward regarding electronic ads in a unified manner with the distributor-identifier.

“distributor-identifier” also has an important technical meaning in that the advertisement intermediation site needs to surely motivate the members to participate in the intermediation transaction of ads for revitalizing the advertisement intermediation site since the present invention is basically an invention related with “intermediation of ads”. If a member who participated in the advertisement intermediation cannot predict the reward for the intermediation activity and expect a definite income, it would be very difficult to expect for the members to revitalize the advertisement intermediation site by distributing the electronic ads.

The characteristics of the present invention relating to the above-described “distributor-identifier” are also in a close relation to the process of monitoring the distribution status of the distributed electronic ads and calculating the advertising result. That is, since the distributed electronic ads are attached with the distributor-identifier at the time of ad-distribution, when the distributed ads are read or clicked, the server of the advertisement intermediation site can not only grasp the advertising result of the distributed electronic ads but also grasp and manage the information about which distributor member is related with the advertising result exactly and certainly.

In other words, the present invention is a method for achieving a vigorous advertisement intermediation transaction by a definite distribution and reward of electronic ads in the advertisement intermediation site, and is adopting a technique to attach the distributor-identifier to the electronic ads distributed via the advertisement intermediation site and thereby making it possible to manage the distribution record and advertising result of electronic ads per the distributor member in a limp at the side of advertisement intermediation site.

In this way, it is possible to reward for the distribution activity of the distributor member definitely since the present invention adopts the component of the distributor-identifier. As described above, since the present invention introduces the distributor-identifier for the distribution motivation of the distributor member and also for the management of distribution and reward of electronic ads in a limp at the side of advertisement intermediation site, the “first advertising fee” is a reward for the distribution activity, which is provided to the distributor member definitely.

Besides, the present invention considers the distribution situation that the electronic ads are distributed in the “text writing area” so as to facilitate the distribution of electronic ads. In case of the prior arts, the electronic ads such as banners were recognized as an outdoor advertising to the website user. Thus, the banners that are almost the same with an outdoor advertising to the web surfing user show explicit intention to approach to the users commercially so that those kinds of ads may be just an irritating stuff for the web users. However, the present invention shows the electronic ads to the network user as a kind of content or information related with the content by applying the electronic ads inside the text writing area because the purpose of improving the effectiveness of advertising result by voluntary participation in advertising cannot be satisfactorily achieved without removing said negative recognition on the electronic ads.

Furthermore, in the first aspect of the present invention, said distributing of the electronic ad may be performed by means of copy-and-paste with copying the electronic ad from a server of the advertisement intermediation site on clipboard and pasting it to said other site, and a text included in the electronic ad copied on the clipboard may be made into an image by the server of the advertisement intermediation site.

This is for removing the possibility of the distributor member modifying the text content of the electronic ads on the copied clipboard without the permission of the sponsor when the advertisement intermediation site provides the electronic ads of text type to the distributor member.

Next, according to the second aspect of the present invention, there is provided an electronic advertisement method using an advertisement intermediation site, comprising: registering an electronic ad of a sponsor with an ad-identifier of the electronic ad on the advertisement intermediation site; receiving a request from a manager member who manages a site to make the site a partner site and establishing a partnership with the site of the manager member with installing an ad-interface in the partner site; distributing the registered electronic ad to the partner site with attaching a distributor-identifier when a distributor member distributes the registered electronic ad to the partner site using the ad-interface; monitoring distribution status, exposure number and click number of the distributed electronic ad using the ad-identifier and the distributor-identifier so as to calculate an advertising result; and rewarding the partner site with a portion of an advertising cost paid by the sponsor as a second advertising fee based on the advertising result at the partner site.

The second aspect of the present invention may be partly modified into an electronic advertisement method using an advertisement intermediation site, comprising: registering an electronic ad of a sponsor with an ad-identifier of the electronic ad on the advertisement intermediation site; distributing the registered electronic ad to other site with attaching a distributor-identifier when a distributor member distributes the registered electronic ad to said other site; monitoring distribution status, exposure number and click number of the distributed electronic ad using the ad-identifier and the distributor-identifier so as to calculate an advertising result; transmitting a partnership request message with the advertising result to a manager of said other site and making said other site a partner site with installing an ad-interface that enables said distributing in the partner site; and ewarding the partner site with a portion of an advertising cost paid by the sponsor as a second advertising fee based on the advertising result at the partner site.

Furthermore, according to the second aspect of the present invention, there is also provided an electronic advertisement method using an advertisement intermediation site that manages a database of at least an electronic ad of at least a sponsor together with an ad-identifier of each electronic ad and interlocks with at least one partner site providing a distribution page where the electronic ad is distributed, comprising: providing an ad-interface that can be placed anywhere inside the distribution page by a distributor member who visits the partner site and is going to distribute the electronic ad to the partner site as a member of the advertisement intermediation site; providing the electronic ad of the database for selection of the distributor member when the distributor member designates a posting position of the ad-interface and securing a distribution history information including the ad-identifier of the distributed electronic ad, an identifier of the distributor member, an identifier of the distribution page and the posting position information when the distributor member selects the electronic ad that will be distributed and loaded through the ad-interface; monitoring distribution status, exposure number and click number of the electronic ad distributed using the ad-interface based on the distribution history information so as to calculate an advertising result; and rewarding the distributor member with a portion of an advertising cost paid by the sponsor as a first advertising fee based on the advertising result.

The above-described second aspects of the present invention are all considering the unique characteristics of the website where electronic ads are distributed. Here, the “unique characteristics” means that the owners of the sites existing in the network such as interne or wireless mobile communication have management authority for their own site but they become mere visitors who don't have management authority in other site. That is, even though the electronic ads had been distributed a lot through the advertisement intermediation site, the distributed electronic ads may be nothing but a kind of bulletin boards that violated the management policy of the site in view of the owner or manager of the site so that there cannot be any advertising result if the owner or manager of the site deletes the electronic ads distributed on his or her site. This is the reason why the present invention adopted the concept of “partner site”.

Therefore, in the present invention, all the manager of the network site has to do is to approve the ad-distribution activity on his or her site by registering the site as a partner site and installing an ad-interface, and then the owner or manager will get paid a predetermined advertising fee for the advertising result occurring in the site (that is, the second advertising fee). Here, the one who distributes the electronic ads through the ad-interface is not the manager of the partner site but the distributor member.

Of course, even the distributor member needs to report his or her ad-distribution activity before completing the distribution of electronic ads so as to get the first advertising reward based on the result of ad-distribution if the distributor member is trying to distribute electronic ads through the ad-interface in the status of non-login to the advertisement intermediation site. Thus, the second aspect of the present invention may further comprise: performing a first claim for the distributor member reporting said distributing activity to the advertisement intermediation site before the electronic ad is distributed when non-member or non-login member of the advertisement intermediation site is trying to distribute the electronic ad, and in this case “distributor member” means a member of the advertisement intermediation site who notified the advertisement intermediation site of his or her ad-distribution activity before completing the ad-distribution. For reference, “first claim” indicates said process for reporting the ad-distribution activity in the present disclosure.

In the meantime, the “ad-interface” in the second aspect of the present invention is a component in the shape of advertisement mark such as text, underline or image, which enables the distributor member to fetch the electronic ads directly from the advertisement intermediation site in the partner site and thus revitalizes the ad-distribution by facilitating the distributing process. When the network user made actions such as on-mouse or click, the ad-interface calls the electronic ads from the advertisement intermediation site and provides them to the network user.

Preferably, the ad-interface may be placed anywhere inside the webpage of the partner site when a network user visiting the webpage fixes the posting position of the ad-interface by means of drag-and-drop and so on. In this case, the only thing the distributor member has to do for the ad-distribution is just clicking the ad-interface, pulling it inside the webpage and dropping it for position fixing. Of course, said drag-and-drop is only an example, and the convenience for the ad-distribution can be amazingly improved by adopting the ad-interface. In this way, the electronic ad distributed in the shape of ad-interface marker inside the body substance of the webpage of the partner site may be used for the network user reading the page substance of the partner site to fetch the electronic ads from the advertisement intermediation site immediately during the reading, and be also used for immediate execution of the ad-distribution process interlocking with the advertisement intermediation site. In this aspect, the ad-interface may be called as “immediate interlocking interface”.

It should be noted that the ad-interface can be posted to anywhere inside the network page of the partner site when the distributor member distributes electronic ads using the ad-interface since the distributor member may be thought to be bestowed with distribution authority in the shape of a tool so-called ad-interface from the partner site manager. It should be understood that the ad-distribution process is performed not by distributing the electronic ad in itself but by inserting the ad-interface inside the body substance of the webpage of the partner site.

Another important thing is that the advertisement intermediation site is required to know the posting position of the ad-interface exactly at the time of the installation of the ad-interface since the partner site is not a site sharing DB information or source code with the advertisement intermediation site but a site supporting the electronic advertising of the advertisement intermediation site. If the advertisement intermediation site does not secure the exact posting position of the ad-interface, the posting position of ad-interface determined by the distributor member might be changed when the network user visiting the webpage of the partner site where the electronic ad is distributed adjusts the size of the web browser or modifies the resolution of the screen. In this case, contextual advertisement cannot be achieved because the advertisement inserted into the body substance of the webpage according to the distributor member's intention to relate the ad with the specific portion of the body substance cannot be guaranteed to stay in the proper position.

Thus, the relative position between the ad-interface and the body substance of the distribution page should be uniformly maintained regardless of the structure, size and resolution of the network browser used by the network user who is visiting the distribution page based on said posting position information.

In the meantime, the present invention adopts the concept of “distribution history information” comprised of the information including the distributed electronic ad, the distribution page, the posting position information and the distributor member's info. This distribution history information is a tool not only for managing the result of electronic advertising but also for achieving the contextual advertisement by maintaining the original posting position of the ad-interface intended by the distributor member.

Furthermore, the identifier of the distribution page among the distribution history information may be a URL of the distribution page or an ID of the distribution page that is created based on page property acquired by the advertisement intermediation site scanning components of the distribution page, and in this case the page property may include at least one of the following page properties: the date of page creation shown in the distribution page, a unique page number given by the partner site for differentiating various pages, IP address of page creator, and the page creator's ID at the partner site.

Since the advertisement intermediation site cannot access the DB information of the partner site without additional contract for sharing DB as described above, it is important for the advertisement intermediation site to secure the page access information besides URL for the preparation of the case that the partner site does not give different URL's per web pages. If the advertisement intermediation site cannot provide the network user who is visiting a webpage of the partner site with the ad-interface because there is no available URL for that webpage, the electronic advertisement method according to the present invention cannot be executed in order. Therefore, the advertisement intermediation site needs to analyze the property of the webpage of the partner site where electronic ad is distributed so as to create and manage the advertisement intermediation site's own page ID, which is referred to find cut the exact webpage where the electronic advertising according to the present invention should be performed.

In the second aspect of the present invention, the detailed method for executing the establishment step of the partner site may be varied. That is, it is possible to encourage the partnership establishment by providing the expected profit that will be rewarded to the site owner or manager on condition of establishing partnership after the electronic ads are distributed and the advertising result at the site is calculated, or it is also possible to provide a guidance message to the site manager at the time of ad-distribution and encourage the partnership establishment by providing afterwards advertising result. In addition, it is also possible to receive a voluntary request for the partnership from a manager member of the advertisement intermediation site who manages his or her own site.

To give an additional remark, in the second aspect of the present invention, the ad-distribution occurring in the partner site may include the following two cases: 1) a case that the ad-distribution is made in the text writing area given by the partner site in itself, and 2) a case that the ad-distribution is made through the ad-interface of the partner site. Therefore, it is preferable to calculate the advertising result at the partner site by the summation of the profit made without the ad-interface and the profit made with the ad-interface.

Summarizing the characteristics according to the second aspect of the present invention, it is possible to mobilize numerous general network users visiting various web pages and sites as ad-distributors since the distributor member of the advertisement intermediation site is able to distribute electronic ads immediately and very easily through the ad-interface especially when the sites visited have a partnership with the advertisement intermediation site. Since all the general network users have to do for ad-distribution is just a very simple mouse operation in the webpage of the partner site, the degree of the convenience for the ad-distribution can be extremely improved. Especially, in consideration of the well-known fact that the number of site visitors is much larger than the number of site managers, the value of the present invention may be much more highly estimated since numerous site visitors may become the subject of advertising activity and the number of ad-distribution may increase enormously.

Also, according to the second aspect of the present invention, the contextual advertisement may be also achieved without giving up said advantages.

That is, by allowing a free location of the ad-interface installed inside the webpage of the partner site, general network users visiting the partner site may come in contact with a brand new type of advertisement. For example, assure that a distributor member who is visiting a blog dealing with a cat food in the partner portal site is going to distribute an ad related with cat food. If the distributor member operates the mouse and determines the posting position of the ad-interface marker right on the picture of a cat included in said cat food blog, a general web user (visitor) reading the same blog with watching the pictures of cats may find a small ad-mark attached to the picture and get curious to know what kind of advertisement will come cut regarding that picture. After clicking the ad-mark on the picture, the visitor may know which food company is sailing cat food product for which cats. In this example, the ad-mark is included in a minimized size of image or text at the blog, so that it does not spoil a fine view of the blog and does not disturb the visual field of visitors. Instead, the ad-mark may be an induction cause for the interest of visitors visiting the blog and may be a useful tool for providing necessary information to visitors. In this way, the ad-interface of mark type introduced by the present invention acts a role in improving the advertising effectiveness by making the network user get interested in advertising and achieving a high degree of contextual advertisement with free positioning technique inside the body substance of electronic bulletin in the partner site, which could not be expected in the prior arts.

Furthermore, it should also be noted that unlike the prior art the writer member of electronic bulletin is not related with the distribution activity at all and does not have to be a manager of the partner site in the present invention, either. That is, since the bulletin writing and ad-distribution is completely separated in the present invention, the one who is only interested in ad-distribution does not have to write bulletins involuntarily, and the one who is only interested in bulletin writing or information sharing can still make advertising income even without doing any further actions besides writing. Therefore, both the bulletin writing and the ad-distribution can be revitalized at the same time. Especially, considering that the number of general network users reading bulletins is much larger than the number of bulletin writers in most cases, the idea or platform of the present invention may be highly appreciated since the ad-distribution and bulletin writing are performed by completely independent subjects and thereby the epochal revitalization of electronic advertising can be achieved.

Next, according to the third aspect of the present invention, there is provided an electronic advertisement method using an advertisement intermediation site that manages a database of at least an electronic ad of at least a sponsor together with an ad-identifier of each electronic ad and interlocks with at least one partner site providing a distribution page where the electronic ad is distributed installing an ad-interface that enables ad-distribution in the partner site, comprising: securing a bulletin of the partner site, a writer-identifier of a writer member who writes the bulletin in the partner site as a member of the advertisement intermediation site, and a bulletin page identifier of the bulletin; providing the ad-interface that can be placed anywhere inside the bulletin page by a distributor member who visits the distribution page and is going to distribute the electronic ad as a member of the advertisement intermediation site; providing the electronic ad of the database for selection of the distributor member when the distributor member designates a posting position of the ad-interface and securing a distribution history information including the ad-identifier of the distributed electronic ad, an identifier of the distributor member, the writer-identifier, an identifier of the distribution page and the posting position information when the distributor member selects the electronic ad that will be distributed and loaded through the ad-interface; monitoring distribution status, exposure number and click number of the electronic ad distributed using the ad-interface based on the distribution history information so as to calculate an advertising result; and rewarding the writer member with a portion of an advertising cost paid by the sponsor as a third advertising fee based on the advertising result.

In said third aspect of the present invention, the third advertising fee is a reward for the writer member who is a member of the advertisement intermediation site and writes bulletins in the partner site and reports the writing activity to the advertisement intermediation site. To achieve the contextual advertisement, it should be understood that securing a lot of bulletins with good quality is also important thing together with securing a lot of sponsor's ads since bulletins with good quality raises the possibility of contextual correlation with electronic ads of various sponsors. Thus, the electronic advertisement method according to the third aspect of the present invention makes the writer member be rewarded with the third advertising fee for the indirect advertisement supporting activity.

Of course, just like the first aspect of the present invention, the third aspect of the present invention may further comprise: rewarding the distributor member with a portion of an advertising cost paid by the sponsor as a first advertising fee based on the advertising result of the distributor member so as to give motivation of ad-distribution to the distributor member. It is also preferable to further comprise: rewarding the partner site with a portion of an advertising cost paid by the sponsor as a second advertising fee based on the advertising result at the partner site so as to secure as many partner sites as possible. Especially, since the second advertising fee gives a strong motivation for the partner site to participate in the advertising intermediation, it may be also very beneficial to the sponsors to secure many partner sites by the second advertising fee. That is, the sponsor may have a beneficial effect of distributing the electronic ad to a number of partner sites by only one advertising contract with the advertisement intermediation site.

In the meantime, it should be noted in the third aspect of the present invention that the advertisement intermediation site needs to acquire a unique ID for the bulletin page (that is, an article ID) when the bulletin writing claim is made at the time of securing bulletins. The detailed method for this may be, for example, using the URL of bulletin page as the unique ID for the bulletin page, or using the given identifiers (alphabet, number, symbol or the combinations thereof) in the bulletin to make a bulletin page ID when the advertisement intermediation site performs the modification process of the electronic bulletin.

Also, it should be noted that the process of securing bulletins is not only applied to the bulletins written after the conclusion of partnership but also applied to the bulletin already existing in the partner site. That is, the present invention may utilize numerous bulletins existing in the network sites unlike Priorart4 and Priorart5.

Thus, in the third aspect of the present invention, the “writer member” includes both the one who is a member of the advertisement intermediation site and writes electronic bulletins in the partner site and the one who first writes electronic bulletins at the partner site and reports the bulletin writing activity later. For reference, the writer member's reporting the bulletin writing activity to the advertisement intermediation site is designated as “second claim” in this disclosure.

Thus, in the third aspect of the present invention, said securing the bulletin of the partner site includes performing a second claim for the writer member reporting an activity of writing the bulletin in the partner site to the advertisement intermediation site when the bulletin page is written by non-member or non-login member of the advertisement intermediation site.

More preferably, said securing the bulletin of the partner site includes judging whether a network user has a rightful authority to amend the bulletin page when the network user is trying the second claim so as to identify whether the network user is a true writer of the written bulletin or not.

That is, if the network user who is performing the second claim is a true writer of the claimed bulletin, the network user shall be provided with an authority to amend the claimed bulletin in most cases. The present invention is using this point to identify the genuineness of the bulletin writer. Therefore, the writer member who is reporting the bulletin writing activity may be judged to be a true writer of the bulletin when the second claim is successfully completed with the trial of the advertisement intermediation site to virtually perform the amendment process without actually modifying the bulletin or visually showing the amendment process to the network user.

Another important thing that should be considered in the third aspect of the present invention is that it might be very complicated work for the writer member to find out every single bulletin written before and report them to the advertisement intermediation site. To solve this problem, said securing the bulletin of the partner site includes: acquiring a property of the bulletin page by scanning components of the bulletin page; analyzing writer property information that shows identification of a true writer of the bulletin page among the acquired property of the bulletin page; and executing the second claim automatically for all the bulletin pages that have a property corresponding with the analyzed writer property information in the partner site.

That is, there are a lot of cases in which written bulletins include some information for identifying who is the writer of the bulletin such as IP, nickname, member ID when a network site allows the writing of bulletins. Thus, if a writer member “A” of the advertisement intermediation site writes a bulletin in the partner site and performs the second claim toward the advertisement intermediation site, for example, the bulletin may include an indicator that the bulletin is written by a person who has a partner site ID “XYZ”. Therefore, once the advertisement intermediation site acquires a linkage between the partner site ID “XYZ” and the advertisement intermediation site ID “A” by a successful second claim, the advertisement intermediation site is able to acknowledge pages having “XYZ” ID in the partner site as bulletins written by the writer member “A” in a lump and automatically after scanning pages existing in the partner site. In this way, the writer member “A” may get the third advertising fees from a plurality of his or her bulletins that are written before, being written now, or going to be written with no need to perform the second claim toward the advertisement intermediation site.

Next, according to the fourth aspect of the present invention, there is provided an electronic advertisement method using an advertisement intermediation site, comprising: provisionally registering an electronic ad of a sponsor introduced by an ad-introducer member with an ad-identifier of the electronic ad and an ad-introducer-identifier and displaying the electronic ad on the advertisement intermediation site; distributing the provisionally registered electronic ad to other site with attaching a distributor-identifier when a distributor member distributes the provisionally registered electronic ad to said other site; monitoring distribution status, exposure number and click number of the distributed electronic ad using the ad-identifier and the distributor-identifier so as to calculate an advertising result; transmitting a formal registration request message to the sponsor of the provisionally registered electronic ad and formally registering the provisionally registered electronic ad on condition of the sponsor paying advertising cost when the sponsor consents to the formal registration request message; and rewarding the ad-introducer member with a portion of the advertising cost as a fourth advertising fee based on the advertising result of the ad-introducer member.

According to the fourth aspect of the present invention, there also is provided an electronic advertisement method using an advertisement intermediation site, comprising: randomly or selectively extracting an electronic ad existing in an arbitrary site, automatically and provisionally registering the electronic ad with an ad-identifier of the extracted electronic ad, and displaying the electronic ad on the advertisement intermediation site; distributing the provisionally registered electronic ad to other site with attaching a distributor-identifier when a distributor member distributes the provisionally registered electronic ad to said other site; monitoring distribution status, exposure number and click number of the distributed electronic ad using the ad-identifier and the distributor-identifier so as to calculate an advertising result; and transmitting a formal registration request message to a sponsor of the provisionally registered electronic ad and formally registering the provisionally registered electronic ad on condition of the sponsor paying advertising cost when the sponsor consents to the formal registration request message.

That is, the electronic advertisement method according to the fourth aspect of the present invention is an invention that enables the advertisement intermediation site to secure as many electronic ads as possible. By introducing the concept of “provisional registration”, it is possible for the ad-introducer to upload the electronic ads to the advertisement intermediation site without the sponsor's agreement to pay the advertising cost. And it is also possible to encourage the sponsor to adopt the provisionally registered electronic ad as the formal registration advertisement by letting the sponsor know the advertising result of the provisionally registered ad for a test period. If the sponsor accepts the formal registration, the ad-introducer member who introduced new electronic ad to the advertisement intermediation site will get paid a predetermined reward. Here, the way to secure as many electronic ads as possible may be the ad-introducer member's ad-introduction from other arbitrary network sites, but it is also possible for the advertisement intermediation site to introduce electronic ads at firsthand by extracting electronic ads existing in the network, or for the member of the advertisement intermediation site to make other sponsor's electronic ad at firsthand and provisionally register it on the advertisement intermediation site.

In the meantime, the fourth aspect of the present invention may further comprise: setting a limitation to prohibit at least one of said displaying, said distributing and said monitoring or deleting the distributed electronic ad in a lump when the formal registration request message is denied by the sponsor, wherein the fourth advertising fee is not provided to the ad-introducer member and a charge rate for the fourth advertising fee for the same ad-introducer member is increased.

That is, since even the provisionally registered electronic ad can still produce advertising result for the sponsor who has not yet approved the formal registration, if a sponsor denied formal registration and thus the ad-introducer or the distributor of the provisionally registered ads cannot take any reward for their activity, displaying, distributing or managing services of electronic ads in the advertisement intermediation site should be prohibited, or deleting the displayed and distributed ads in a limp at the advertisement intermediation site is required for the purpose of equilibrium with the other sponsors who finished formal registration. Also, even the ad-introducer member whose advertisement is denied by the sponsor still needs to be acknowledged for his or her effort to participate in the securing of electronic ads, so that it would be better for the advertisement intermediation site to give another advantage to the rejected ad-introducer member (that is, an ad-introducer member whose provisionally registered advertisement is eventually denied by the sponsor) for the purpose of compensation. In this case, if the electronic ad which is provisionally registered by the ad-introducer member is disapproved by the sponsor, the charge rate of the fourth advertising fee for the ad-introducer member will be raised so that the ad-introducer member may get a compensation for the ad-introducing activity when the ad-introducer member introduces another electronic ad later. Therefore, the ad-introducer may participate in introducing electronic ads positively even though the approval of the sponsor cannot be guaranteed.

Preferably, the electronic advertisement method may further comprise: rewarding the distributor member with a portion of an advertising cost paid by the sponsor as a first advertising fee based on the advertising result of the distributor member when the sponsor consents to the formal registration request message, wherein the fourth advertising fee is not provided to the ad-introducer member when the sponsor denied the formal registration request message, and a charge rate of the first advertising fee that will be applied to the distributor member who distributed the denied provisionally registered electronic ad or the ad-introducer member who introduced the denied provisionally registered electronic ad is increased for the same distributor member or the same ad-introducer member. In this case, the ad-introducer member may get a compensation for the rejected ad-introducing activity when the ad-introducer member distributes the electronic ads as a distributor member later even though the ad-introducer cannot take a fourth advertising fee. Therefore, it is worth provisionally registering electronic ads regardless of the sponsor's approval. Likewise, the distributor member who distributed the provisionally registered electronic ads and eventually did not get the first advertising fee because of the disapproval of the sponsor may still get a chance to take a compensation for his or her rejected distribution activity by the raised charge rate of the first advertising fee afterwards.

Preferably, the electronic ad or the ad-interface includes a reply area in itself that allows the estimation or comment on the quality or reliability of the distributed electronic ads. This may help to increase the advertising result of the distributed electronic ads.

More preferably, a member of the advertisement intermediation site is provided with a management interface that enables management of the distribution status of the electronic ad. Since a member of the advertisement intermediation site may act multiple roles of sponsor, partner site manager, ad-introducer or ad-distributor freely, the unified management interface is for easy understanding of the various advertising status and result caused by his or her multiple roles. This management interface may be read by other members of the advertisement intermediation site and this may be helpful to create a kind of community relating with advertisement intermediation so as to exchange various ideas on the advertisement intermediation activities. Thus, said management interface is preferably made as a type of mini-homepage or blog. Also, the ad-management interface may be provided with graphs, so that the member of the advertisement intermediation site may understand the distribution trend of electronic ads at a look and have fun with grasping the intermediation tendency of electronic ads and feeling as if the member is playing a game.

Furthermore, the distributed electronic ad preferably includes a re-distribution interface that enables additional distribution of the distributed electronic ad to another site, and the present invention may further comprise: re-distributing the distributed electronic ad to said another site using the re-distribution interface by the distributor member of the advertisement intermediation site, wherein the distributor member includes a member who re-distributed the electronic ad

For example, in case of the interne environment, the distributed electronic ad may include a “re-distribution” button inserted by HTML code. In this case, a general web user reading the distributed electronic ad may click this “re-distribution” button so as to copy the electronic ads together with the ad-identifier and the identifier of the re-distributor member on the clipboard. Thereby, it is possible to support the re-distributor member to paste the copied electronic ad on another site. Of course, to secure the identifier of the re-distributor member, the re-distributor member needs to accesses the advertisement intermediation site with a membership (that is, executing the first claim). After the re-distribution process is finished, both the re-distributor member and original distributor member may get paid the first advertising fees with differentiated charge rate just like the multi-level reward system.

In the first to fourth aspects of the present invention, the electronic ad may be made by an ad-making tool provided by the advertisement intermediation site.

Also, said distributing of the electronic ad is preferably performed on an electronic map that reflects a geographical information of the electronic ad. Executing the distribution of electronic ads on the electronic map where the geographical identification is visually possible may increase the curiosity or interest in distributing electronic ads. Moreover, the network user reading the electronic ads may also view the electronic ads of sponsors who provide merchandizes or services on the desired location of the electronic map, and thus the advertising effectiveness may be maximized with geographical help.

Finally, the fifth aspect of the present invention provides an electronic advertisement system using an advertisement intermediation site that includes a main server for providing network site, a database server for managing at least an electronic ad of at least a sponsor together with an ad-identifier of each electronic ad and a settlement server and interlocks with at least one partner site having an installation of a partner code and providing a distribution page where the electronic ad is distributed, wherein the partner code calls and executes an advertisement intermediation script of the advertisement intermediation site on a terminal of network user visiting the partner site, and wherein functions of the advertisement intermediation script comprising: securing a bulletin of the partner site, a writer-identifier of a writer member who writes the bulletin in the partner site as a member of the advertisement intermediation site, and a bulletin page identifier of the bulletin; providing an ad-interface that can be placed anywhere inside the bulletin page by a distributor member who visits the distribution page and is going to distribute the electronic ad as a member of the advertisement intermediation site; providing the electronic ad of the database for selection of the distributor member when the distributor member designates a posting position of the ad-interface and securing a distribution history information including the ad-identifier of the distributed electronic ad, distributor-identifier, writer-identifier, distribution page identifier and posting position information when the distributor member selects the electronic ad that will be loaded through the ad-interface; monitoring distribution status, exposure number and click number of the electronic ad distributed using the ad-interface based on the distribution history information so as to calculate an advertising result; and rewarding the distributor member, the partner site and the writer member with a portion of an advertising cost paid by the sponsor as a first, second and third advertising fee based on the advertising result, respectively.

That is, in view of system, the partner site of the present invention may be defined as a site that installed a partner code provided by the advertisement intermediation site, and this partner code is transmitted to the terminal of the network user together with the contents of the webpage when the terminal of the network user is accessing the partner site server and requesting the webpage. The partner code transmitted to the terminal of the network user executes a calling process that calls and activates the scripts prepared in the advertisement intermediation site. These scripts are comprised of a plurality of functions that reports the bulletin writing activity, ad-distribution activity or ad-reading activity of a network user to the advertisement intermediation site and also loads the ad-interface or electronic ads from the advertisement intermediation site and transmits various messages that will be described later in this disclosure.

Of course, it should be noted that the system that executes the electronic advertisement method according to the present invention does not have to be structured like the system described above. For example, instead of the advertisement intermediation site, the partner site may in itself have the scripts comprised of functions that execute the electronic advertisement method according to the present invention. In this case, the partner site will be more deeply involved in the advertisement intermediation and thus the partner site is probably able to modify the script provided from the advertisement intermediation site to coincide with its own policy as a matter of convenience. Also, for example, the posting position where the ad-interface is installed may be properly changed based on the necessary policy of the partner site. Thus, above-described electronic advertisement system is not a sole solution for executing the electronic advertisement method of the present invention.

In the fifth aspect of the present invention, the advertisement intermediation script preferably performs a partner judgment process for judging whether the partner code is normally executed in the partner site or not because the advertisement intermediation site needs to find cut whether the manager member who wants the partnership with his or her own website has a genuine authority on the website. Thus, it is advantageous to go through the process for judging the genuineness of the manager authority of the one who requested the partnership by executing the function that identifies whether the partner code installed in the partnership-requested website is properly operating.

More preferably, in the electronic advertisement system, the advertisement intermediation site acquires an ad-introducer-identifier of an ad-introducer member of the advertisement intermediation site who provisionally registers the electronic ad on the advertisement intermediation site together with the ad-identifier of the provisionally registered electronic ad, and the advertisement intermediation script performs said providing the ad-interface, said distributing and said monitoring of the provisionally registered electronic ad, and the advertisement intermediation site transmits a formal registration request message to a sponsor of the provisionally registered electronic ad and formally registers the provisionally registered electronic ad on condition of the sponsor paying advertising cost when the sponsor consents to the formal registration request message.

In this way, the profit sharing system adopted in the electronic advertisement system according to the fifth aspect of the present invention is composed to divide the advertising cost paid by the sponsor into several portions and provide fair different advertising fees with different technological meanings to the distributor member, the manager member of the partner site, the writer member and the ad-introducer member, respectively. Of course, the advertisement intermediation site will take the remaining advertising cost as a management profit. Therefore, said profit sharing system is not only for the advertisement intermediation site, and adopts a very peculiar profit sharing structure for encouraging as many advertising subjects as possible to participate in advertising so as to fully utilize the advertising cost paid by the sponsor for maximizing the advertising result.

### Advantageous Effects

In accordance with the embodiments of the present invention, there is a beneficial effect that electronic advertisement may be revitalized by enormously increasing the number of ad-distribution since any members of an advertisement intermediation site are able to distribute electronic ads to any sites existing in the network so as to take rewards.

There is another beneficial effect that advertising result may be maximized by achieving the contextual advertisement with unspecific multiple network users being still able to easily distribute electronic ads to any other sites at anytime via the advertisement intermediation site.

There is yet another beneficial effect that the contextual advertisement may be strengthened by constructively utilizing the electronic bulletin pages of the partner site in distributing electronic ads through the advertisement intermediation site.

Furthermore, there is also a beneficial effect that electronic advertising may be revitalized by obtaining and seaming electronic ads which are intermediation objects for advertising in the advertisement intermediation site.

### BRIEF DESCRIPTION OF THE DRAWINGS

The disclosure may be best understood by reference to the following description taken in conjunction with the following figures:

FIG. 1 depicts an example of an electronic advertisement system according to a prior art.

FIG. 2 depicts another example of an electronic advertisement system according to a prior art.

FIG. 3 depicts an entire structure of an electronic advertisement system according to an embodiment of the present invention.

FIG. 4 depicts an example of an interface for registering electronic ads on an advertisement intermediation site according the present invention.

FIG. 5 depicts an example of formal registration request message for electronics ads provisionally registered by an ad-introducer member.

FIG. 6 depicts an example of partnership request message according to the present invention.

FIG. 7 is a flow chart that shows a process for making a partner relationship between an advertisement intermediation site and a partner site according to an embodiment of the present invention.

FIG. 8 depicts an example of an interface provided by an advertisement intermediation site for executing distribution step according to the present invention.

FIG. 9 and FIG. 10 illustrate a case that electronic ads are distributed by using an ad-interface on the webpage of a partner site according to an electronic advertisement method of the present invention.

FIG. 11 is a flow chart that shows a process for distributing electronic ads to distribution page of a partner site according to an electronic advertisement method of the present invention.

FIG. 12 illustrates how to execute a re-distribution interface according to an embodiment of the present invention.

FIG. 13 depicts an example of a bulletin page written in a partner site.

FIG. 14 is a flow chart to illustrate how an electronic bulletin is written on the webpage of a partner site according to an embodiment of the present invention.

FIG. 15 depicts an example of a unified management interface for an ad-introducer, a distributor, a writer and a partner site manager according to the present invention.

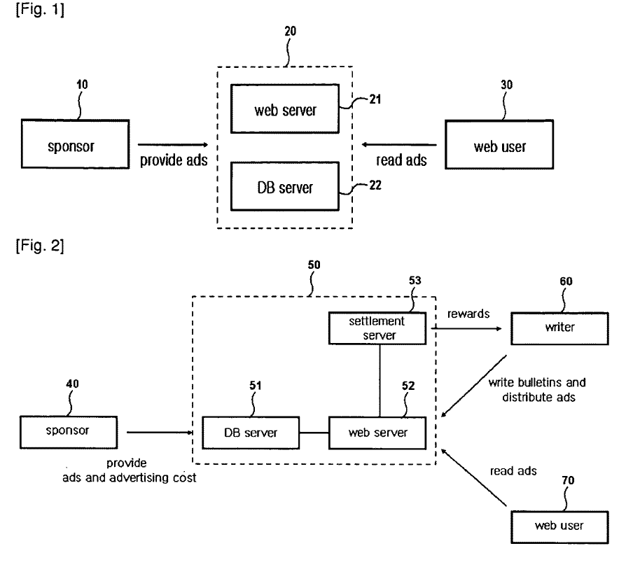

### BEST MODE FOR CARRYING OUT THE INVENTION

Hereinafter, embodiments of the present invention will be described in detail with reference to the accompanying drawings so that the present invention may be readily implemented by those skilled in the art. However, it is to be noted that the present invention is not limited to the embodiments but can be realized in various other ways. In the drawings, parts irrelevant to the description are omitted for the simplicity of explanation, and like reference numerals denote like parts through the whole document.

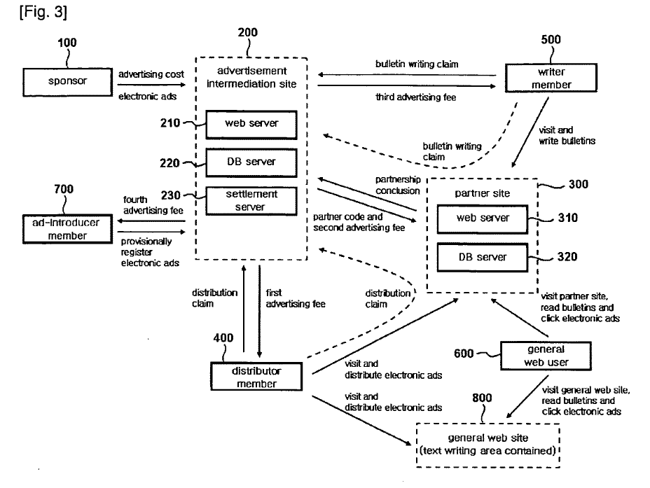

FIG. 3 depicts an entire structure of an electronic advertisement system 900 according to an embodiment of the present invention. Referring to FIG. 3, a sponsor 100 makes an advertising contract with an advertisement intermediation site 200 and provides the advertisement intermediation site 200 with electronic ads, and also pays a predetermined advertising fee to the advertisement intermediation site 200 as a price of advertisement intermediation that will be performed with the joint effort between the advertisement intermediation site 200 and the partner site 300.

To give an additional remark, the sponsor 100 may be comprised of any type of terminal that supports network function such as wireless mobile communication in addition to PC capable of internet connection, and it is also possible to install an application program in the terminal of the sponsor 100 so as to apply the electronic advertisement method of the present invention even when the terminal state of the sponsor 100 is not connected the web server 210 of the advertisement intermediation site 200 with an internet explorer, which may be the same case for a distributor member 400, a writer member 500, a general web user 600 and an ad-introducer member 700.

The advertisement intermediation site 200 is, for example, a site provided by the web server 210 as a website type on the internet and includes a DB server 220 and a settlement server 230. The DB server 220 manages the database of electronic ads provided by the sponsor 100 and also stores and manages membership information including ID's or account number of the sponsor member 100, the manager member 300, the distributor member 400, the writer member 500 and the ad-introducer member 700. In addition, the settlement server 230 performs the accumulation/payment of the advertising fee paid by the sponsor 100 and the first to fourth rewards each to be paid to distributor member 400, partner site 300, writer member 500 and ad-introducer member 700 and also manages the breakdown thereof.

The advertisement intermediation site 200, for example, prepares a “partner code” with a type such as <script src=‘http://www.youcrad.com/partner/UCRAD_partner.js’> and provides this to the partner site 300 that has contracted a partner relationship. Said partner code is a code that can be easily inserted into a site or page by means of pasting the code inside the source code of a website so that a partner site manager may insert that code into the web pages in which the partner site manager wants to execute the electronic advertisement method of the present invention. Said partner code performs interlocking of the terminal of a web user who visited the partner site 300 with the “advertisement intermediation script file” prepared by the advertisement intermediation site 200 to execute detailed processes of the electronic advertisement method of the present invention such as distribution of electronic ads and distribution claim, writing claim for the bulletin, managing of advertising result and so on.

Moreover, the advertisement intermediation site 200 according to the present invention supports the distribution of electronic ads not only for the partner site 300 but also for the general website 800. This requires a condition that the general website 800 contains a text writing area because the text writing area has a possibility to be used for an advertisement purpose instead of pure writings so far as the text writing area is permitted in a website. Thus, the advertisement intermediation system 900 according to the present invention proposes a model in which the advertising result occurs when a distributor member 400 distributes an electronic ad from the advertisement intermediation site 200 to arbitrary websites 300, 800 and another general web user 600 clicks the distributed ad whereas the prior art such as Priorart2 proposed a model in which the advertisement result occurs by the general internet user's click on the distributed electronic ads provided by the advertisement intermediation server and delivered to the website by the website manager.

The partner site 300 may be an internet site such as a portal site provided by a web server 310 and adopt membership or non-membership management policy and provides at least a webpage to a general web user 600. In other words, the partner site 300 in the present invention may be any conventional general website existing in the internet as far as it simply installs the partner code, which requires the manager of the partner site 300 to subscribe to the advertisement intermediation site 200 and finish the partner conclusion process. The partner site 300 of the present invention may be called a site that provides a cyber-space for the internet distribution of electronic ads by installing the partner code so as to create ad-interface capable of interlocking with the advertisement intermediation site 200 and thus making the distribution of electronic ads easier.

When the partner conclusion process is completed, the partner site 300 provides an internet space in which the distribution of electronic ads possessed by the advertisement intermediation site 200 occurs and takes a second advertising fee for it. Here, it should be noted that the partner site 300 does not directly take part in the distribution of electronic ads or management of advertising result. The partner site 300, for example, only installs said partner code provided by the advertisement intermediation site 200 into the webpage included in its site. Therefore, The terminals of a distributor member 400, a writer member 500 and a general web user 600 will load a partner code with said exemplified <.JS> type and a content both provided by the web server 310 of a partner site 300 when they visit the partner site 300, and after that, the loaded partner code will call an advertisement intermediation script file of the advertisement intermediation site 200 and thereby the web server 210 and the DB server 220 of the advertisement intermediation site 200 automatically executes the electronic advertisement method according to the present invention with interlocking with the terminals of the distributor member 400, the writer member 500 and the general web user 600.

In the meantime, the distributor member 400 is a member of the advertisement intermediation site 200 and is a component which distributes electronics ads to a partner site 300 and takes a reward of a first advertising fee from the advertisement intermediation site 200 based on the advertising result of his or her advertising result. When the distributor member 400 distributes electronic ads, the advertisement intermediation site 200 provides the electronics ads attached with the identifier (for example, member ID) of the distributor member 400. That is, in the advertisement intermediation system 900 according to the present invention, managers of the partner site 300 or the general website 800 are not the subject of advertisement distribution, and instead of it every member that wants to have a role for a distributor member 400 as a member of the advertisement intermediation site 200 may become a subject of the advertisement distribution. Therefore, said identifier of the distributor member 400 attached when an electronic ad is distributes is for tracing the advertising result per the distributor member 400 so as to give some of the advertising cost paid by the sponsor 100 as a reward, which is called a first advertising fee, to the distributor member 400.

To give an additional comment, the distributor member 400 may be a member of the advertisement intermediation site 200 and at the same time a member of a partner site 300, but fundamentally the advertisement intermediation site 200 does not necessarily require that a distributor member 400 be a member of a partner site 300. The reason for this is that, as can be seen in the dotted arrow “distribution claim” of FIG. 3, even when the partner site 300 does not have a membership policy or a non-member of the partner site 300 distributes electronic ads, the distributor may be acknowledged to have participated in the electronic advertising according to the present invention as far as the distributor claims his or her distribution activity toward the advertisement intermediation site 200 in distributing electronic ads to the partner site 300.

The writer member 500 is a member of the advertisement intermediation site 200 and a component that writes an electronic bulletin on the webpage of the partner site 300 and indirectly participates in advertising by taking a third advertising fee, which is a reward for providing a content to be used for the contextual advertisement. As is the case of the distributor member 400, the writer member 500 may be a member of the advertisement intermediation site 200 and at the same time a member of the partner site 300, but may also be non-member of the partner site 300 because there may exist a case that a partner site 300 adopts a policy of allowing non-members to write bulletins so that even non-members of the partner site 300 may participate in advertising according to the present invention by taking a process so-called “bulletin writing claim”, which is a reporting action for the writer's bulletin writing toward the advertisement intermediation site 200 as depicted in an dotted arrow of FIG. 3.

Next, the ad-introducer member 700 is a member that introduces electronic ads to the advertisement intermediation site 200 and participates in electronic advertising according to the present invention by taking a fourth advertising fee, which is a reward for uploading electronic ads as intermediation objects to advertisement intermediation site 200. However, unlike the sponsor 100, the ad-introducer member 700 does not pay an advertising cost and does not possess his or her own electronic ads for PR. Instead, the ad-introducer member 700 provisionally register the electronic ads of potential sponsors 100 on the advertisement intermediation site 200 before having the approval of the sponsors 100, and will be rewarded a fourth advertising fee only when the sponsor 100 identifies the provisional advertising result produced by the distribution of the provisionally registered electronic ads to a general website or partner site 300 according to the present invention and confirms the payment intention of the advertising cost, or a consentient intention for the formal registration of the provisionally registered electronic ads.

The general web user 600 is a component that is exposed to advertising when visiting a general website 800 to see electronics ads distributed by the distributor member 400 or visiting the partner site 300 to read electronic bulletins written by the writer member 500 and clicking or performing on-mouse on the advertisement interface installed by the distributor member 400 at the time he or she founds an interesting part in the text content of the bulletins. However, the general web user 600 in the present invention may be readily acting various roles such as 1) a sponsor who pays a predetermined advertising cost and becomes a sponsor member of the advertisement intermediation site 200 to distribute and advertise his or her own electronic ads, 2) a partner that creates his or her own website and makes a partner relationship with the advertisement intermediation site 200 as a manager of the created website so as to take a profit of predetermined second advertising fee, 3) a writer member 500 that writes an electronic bulletin on the partner site 300 and providing a claim for his or her writing action so as to take a profit of third advertising fee, or 4) a distributor member 400 that distributes electronic as to the partner site 300 and provides a claim for his or her distribution activity to the advertisement intermediation site 200 so as to participate in advertising and take a profit of a first advertising fee.

In other words, one member of the advertisement intermediation site 200 is able to act multiple roles since the meaning of “member” in the present disclosure incorporates the following five concept: a sponsor member that makes an advertisement business with the advertisement intermediation site 200, a manager member of partner site 300 that provides a distribution place of electronics ads interlocking with the advertisement intermediation site 200 by the qualification of the owner or manager of the website so as to take a reward from the advertisement intermediation site 200, a distributor member 400 that distributes sponsor's electronic ads so as to take a reward according to the advertising result, a writer member 500 that writes a bulletin on the partner site 400 and reports the writing action to the advertisement intermediation site 200 so as to take a reward according to the advertising result occurring by the electronic ads distributed in the reported or claimed bulletin, and an ad-introducer member 700 that provisionally register electronic ads on the advertisement intermediation site 200 and take a reward on condition of formal registration.

Now, to explain more detailed aspects of the advertisement intermediation system 900 according to the present invention, the main functions executed by the advertisement intermediation system 900 will be classified into the following five items:

I. Introduction of electronic ads and Approval on provisionally registered ads, II. Conclusion of partner relationship, III. Distribution of electronic ads, IV. Securing of electronic bulletin, and V. Reading of electronic ads and Management of advertising result.

I. Introduction of Electronic Ads and Approval on Provisionally Registered Ads

The advertisement intermediation server 210 has to introduce electronic ads to the advertisement intermediation site 200 for advertisement intermediation on the internet. There are following four types for introducing electronic ads (that is, receiving and registering electronic ads):

\textcircled{1} Receiving the electronic ads that the sponsor 100 wants to register from the sponsor 100, storing them in the DB server 220 of the advertisement intermediation site 200, and registering and displaying on the advertisement intermediation site 200 (hereinafter, “Introduction type 1”).

\textcircled{2} Gathering electronic ads existing in arbitrary websites by searching robot (or, searching program) of the advertisement intermediation site 200 and automatically introducing them to the advertisement intermediation site 200 (hereinafter, “Introduction type 2”).

\textcircled{3} Receiving electronic ads transmitted by the ad-introducer member 700 and provisionally registering and displaying them on the advertisement intermediation site 200 (hereinafter, “Introduction type 3”).

\textcircled{4} Receiving electronic ads made by members of the advertisement intermediation site 200 using an advertisement making tool through the web server 210 and provisionally registering and displaying them on the advertisement intermediation site 200 (hereinafter, “Introduction type 4”).

Introduction type 1 among the above-described introduction types is the most fundamental and typical introduction path of electronic ads. This type is a case that the sponsor 100 introduces his or her own electronic ads with the intention of paying advertising cost after the conclusion of advertisement contract. Therefore, it can be understood that the sponsor 100 confirmed an approval about the formal registration of the electronic ad, the selection among the electronic ads (that is, which advertisement should be registered on the advertisement intermediation site among the sponsor's various ads), the distribution of electronic ads, and the ad-cost payment for the advertising result.

Here, various ad-cost policies including a flat rate, a fixed rate, a prepayment, a post-payment, a period-advertising may be applied in the present invention, but it would be preferable to contract the amount of ad-cost per click on each electronic ad and settle the accumulated ad-cost for every predetermined unit periods.

In contrast, Introduction type 2 to 4 are cases that the electronic ads are provisionally registered on the advertisement intermediation site 200 without the sponsor's approval or permission. Therefore these three types necessarily require a post-process for having an approval or disapproval from the sponsor 100 so as to identify whether the electronic ads displayed and distributed without sponsor's permission are allowed to produce advertising outcomes afterwards. Of course, the sponsor's approval may probably do not matter if the sponsor 100 is given a free right to use the advertisement intermediation site 200, but it should be noted that even in this case the sponsor 100 may want to have an approval or disapproval process so as to prohibit the electronic ads thought as including inferiority or badness from being displayed and distributed without his or her permission.

It should be also noted that said Introduction type 2 to 4 requires an additional process in preparation for the case that the sponsor 100 showed a disapproval intention of not formally registering the provisionally registered ads. This is because the electronic ads that the sponsor 100 denied formal registration may still make an advertising result in the distribution status. Therefore, it is preferable to delete the distributed electronic ads in a limp so as to terminate the situation of displaying and distributing the electronic ads or to set a limitation so as to prohibit at least one of following services: the ad-display on the advertisement intermediation site 200, distribution step and management step for advertising when the advertisement intermediation site 200 receives the disapproval about the formal registration request message from the sponsor 100. At the same time, it is preferable to raise the earmarking rate of the first advertising fee in regard to the later-on distribution activity of the rejected ad-introducer member 700 so as to provide some reward for the introducing action to the ad-introducer member 700. Also, it is preferable to raise the fourth advertising fee when the ad-introducer member 700 introduces another electronic ad again so as to take the rejection history of the ad-introducer member 700 into account Likewise, it would be possible to raise the earmarking rate of the first advertising fee for the in regard to the later-on distribution activity of the distributor member 400 who distributed provisionally registered electronic ads so as to compensate for the invalidated distribution activity by the sponsor's disapproval or rejection.

In the meantime, to achieve Introduction type 2, the advertisement intermediation site 200 needs to have an ad-searching program or robot, which may be implemented by the robot that includes a script that executes visiting arbitrary websites, a script that executes searching ad indication code such as “AD” tag among the tags of bulletins existing in the visited websites, and a script that executes transmitting the ad indication code and bulletins to the advertisement intermediation site 200.

Regarding Introduction type 3, it may be implemented by letting the ad-introducer member 700 who is a member of the advertisement intermediation site 200 bring electronic ads about arbitrary merchandize or service found in the interne to the advertisement intermediation site 200 by copy-and-paste or path-designation of the ads.

Regarding Introduction type 4, it may be implemented by an ad-making tool provided by the advertisement intermediation site 200, and in this case the ad-making tool may be a banner creating tool, UCC making tool, or a tool supporting the combination of text, image and sound.

When the advertisement intermediation site 200 introduces electronic ads by Introduction type 3 and 4, it is necessary to give an identifier of ad-introducer member to the introduced electronic ads. Since Introduction type 3 and 4 are means for revitalizing the advertisement intermediation by introducing various and many electronic ads, the ad-introducer member 700 who participated in the introduction of electronic ads deserves to have a reward and thus it is preferable to continuously manage the advertising result of electronic ads introduced by the ad-introducer member 700 through the identifier of the ad-introducer member 700.

The advertisement intermediation site 200 displays the electronic ads introduced by said Introduction type 1 to 4 on its website for ad-intermediation. In this case, it is preferable to include an admission step for the electronic ads to be displayed since the advertisement intermediation site 200 according to the present invention is not only a space to bring and spread cut electronic ads but also is a kind of search portal site. In other words, the electronic ads registered on the advertisement intermediation site 200 are objects that creates profit for the distributor member 400, but they are at the same time information contents providing some information about specific merchandize or service in the advertisement intermediation site 200 so that it is not desirable to introduce and display electronic ads that contradict good public order and customs without any control in the advertisement intermediation site 200.

In the meantime, when including said admission step, it is more preferable to register and display the electronic ads according to membership information such as member's age on the advertisement intermediation site 200.

Also, it is possible to give an ad-property to the electronic ads when it is introduced. Here said ad-property means an advertisement wording, category or keyword for advertisement searching that correspond to the electronic ads. These properties given to the electronic ads may be provided together with the advertising result in setting the category, advertisement wording, keyword, etc of the electronic ads to be introduced by the sponsor or the ad-introducer member, which may be used for the sponsor or the ad-introducer member judging which category setting or keyword setting for the introducing ads will be best for maximizing the advertising result.

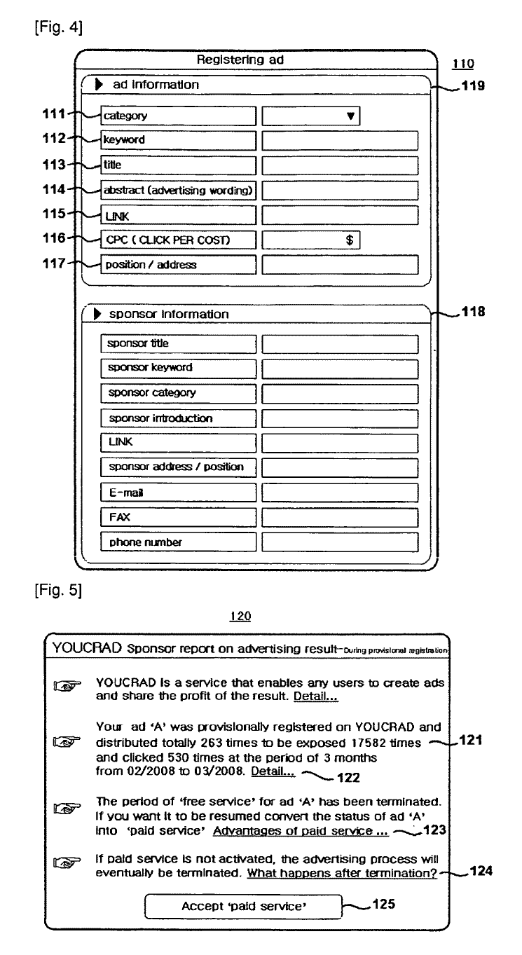

Now, the way how to upload the electronic ads to the advertisement intermediation site 200 by said Introduction type 1 and 3 will be explained with reference to FIG. 4.

FIG. 4 depicts an example of an interface 100 for registering electronic ads on an advertisement intermediation site 200 according the present invention. Referring to FIG. 4, an ad-information making window 119 is given to the sponsor 100 or the ad-introducer member 700 who is going to register electronic ads on the advertisement intermediation site 200.

The sponsor 100 or the ad-introducer member 700 fills out the category input box 111, keyword input box 112, title input box 113 and abstract or advertising wording input box 114 in accordance with the wish on which category, keyword, title and advertising wording should represent the electronic ad on the advertisement intermediation site 200. Also, the LINK input box 115 should be filled out as the domain or URL to be launched when the electronic ad is clicked. Of course, it may be ok to let the LINK input box 115 blank if the sponsor 100 wants to register the electronic ad of text type without additional link for it.

Next, the sponsor 100 needs to fill cut the CPC input box 116 according to the amount of the cost that he or she is willing to pay. Here, CPC means “COST PER CLICK”, which is advertising cost that has to be paid when the electronic ad is clicked once. Of course, if the advertising result is acknowledged even when the electronic ad is just exposed to a general web user 600 without a click, the CPC input box 116 may be filled with an advertising cost that has to be paid to the advertisement intermediation site 200 by the sponsor 100 when the electronic ad is exposed once. A high CPC may reinforce the distributor member 400's motivation for distributing electronic ads.

For reference, the fact that the sponsor 100 who is filling cut the ad-information making window 110 filled out the CPC input box 116 indicates that the sponsor 100 has a willing to pay the advertising cost for the registering electronic ad, so that when the electronic ad which contains CPC information produces advertising outcomes the distributor member 400, manager member of the partner site 300 and the writer member 500 will be paid the first to third advertising fee respectively, whereas in case of the provisionally registered electronic ads these advertising fees can be paid only when the provisionally registered electronic ads are approved by the sponsor 100.

If the ad-introducer member 700 is filling out the ad-information making window 110, the CPC input box 116 may be deactivated since the ad-introducer member 700 is not a subject who pays the advertising cost unlike the sponsor 100.

Next, the sponsor 100 or the ad-introducer member 700 needs to designate the geographic base of the electronic ads when filling cut the position/address input box 117. The position/address input box 117 is not a mandatory input item. However, for instance, when an ad is for a restaurant service “California Korean Restaurant” which exists in “Menlo Park Calif. 94025, US”, the sponsor 100 of the restaurant may fill out the position/address input box 117 with the address of “Menlo Park Calif. 94025, US” and in this case it is also possible for the advertisement intermediation site 200 to activate an electronic map and attach this electronic ad on the right position of the electronic map so as to advertise the electronic ad with geographical understanding. Moreover, it is possible to provide the sponsor 100 or the ad-introducer member 700 with an electronic map indicated with latitude and longitude so as to have an position/address input box filled out with the latitude/longitude information of the electronic ad, or it is also possible to provide the sponsor 100 or the ad-introducer member 700 with an entire electronic map so as to let the sponsor 100 or the ad-introducer member 700 bring his or her electronic ad directly on the related position of the electronic map for the formal or provisional registration of the electronic ads. Here, the electronic map is a map provided on the web for the members of the advertisement intermediation site 200, which may be stored and managed by the DB server 220 or a map company that provides a map service on the internet including a partner site and other arbitrary website. The member who is going to distribute the electronic ads may use this electronic map for searching and distributing the electronic ads by the regional basis.

In the end, the sponsor 100 or the ad-introducer member 700 needs to input abstract information related with the sponsor of the electronic ads introduced to the advertisement intermediation site 200 using the sponsor information window 118.

In the meantime, in case of said Introduction type 2, the advertisement intermediation site 200 uses a robot to automatically introduce electronic ads to the DB server 220 of the advertisement intermediation site 200, and thus the processes for filling out the ad-information making window 110 depicted in FIG. 4 are not necessary and the advertisement intermediation site 200 will extract electronic ads with AD tags surfing internet sites to provisionally register the electronic ads according to the category and keyword automatically found to be optimal.

FIG. 5 depicts an example of formal registration request message 120 for electronics ads provisionally registered by an ad-introducer member 700. It should be noted that the concept of “formal registration” is equally treated as “paid service” in FIG. 5. That is, since the electronic ads provisionally registered through Introduction type 2 to 4 does not yet have the sponsor's intention to pay the advertising cost, the advertisement intermediation site 200 needs to transmit a message 120 together with temporary advertising result acquired after executing the distribution and management step of the present invention for a predetermined period to the potential sponsor 120 for the approval of paid service or formal registration of the provisionally registered electronic ads and receives an approval from the sponsor 100 for this message 120.

Referring to FIG. 5, the formal registration request message 123 includes an abstract information 121 of the advertising result acquired during the electronic ad's provisional registration status and also includes a link 122 for showing a detailed advertising result. Also, the formal registration request message 120 includes a PR wording 123 that informs the sponsor 100 of advantages of approving paid service for the provisionally registered electronic ads and a guidance wording 124 that informs the sponsor 100 of the situation that will happen after the disapproval on the message 123. The sponsor 100 may approve the formal registration of the provisionally registered electronic ads using the paid-service subscribing button 125. For reference, “YOUCRAD” in FIG. 5 is a tentative name of the advertisement intermediation site 200 according to the present invention.

### II. CONCLUSION OF PARTNER RELATIONSHIP

As described above, the present invention takes the unique characteristics of the network site in which the electronic ads are distributed into account and thereby adopts a peculiar concept, so called “partner site” in the advertisement intermediation system 900. Hereinafter, sub-items of definition of partner site, conclusion method for partner site and effect of conclusion or non-conclusion of partner relationship will be specifically described for the full understanding about the partner site.

II1. Definition of Partner Site

In the present invention, a partner site is defined as a site that the manager or owner of the site approved the distribution of electronic ads via the advertisement intermediation site 200 and also installed an ad-interface which is for the distributor member 400 easily bringing electronic ads from the advertisement intermediation site 200. The present invention reinforces the distribution power of electronic ads and also achieves contextual advertisement by adopting a peculiar component, partner site in the advertisement intermediation system 900.

### II2. CONCLUSION METHOD FOR PARTNER SITE

There are the following three types of conclusion method for partner site.

\textcircled{1} Transmitting a partnership request message that includes a partner conclusion interface to the manager of a site in which the electronic ad is distributed from the advertisement intermediation site 200 by the distributor member 400, and afterwards providing the site manager with advertising result temporarily acquired by test advertising in the status of non-partner so as to incite the site manager to the conclusion of the partner relationship (hereinafter, “Partner conclusion type 1”).

\textcircled{2} Finding the total of advertising result for a predetermined period when the distributor member 400 distributes electronic ads to a site without identifying whether the site is partner site or not, and providing the site manager with the total advertising result so as to let the manager know how much the second advertising fee will be given if the partner relationship is made and thereby incite the site manager to the conclusion of the partner relationship (hereinafter, “Partner conclusion type 2”).

\textcircled{3} Receiving a URL of a site that is managed by a member of the advertisement intermediation site 200 when the member requests a partner relationship, and performing an qualification examination for partner site and registering the site as a partner site based on the result of the qualification examination (hereinafter, “Partner conclusion type 3”).

Said Partner conclusion type 1 and 2 are based on the consideration that the electronic ads distributed to a site may be treat as illegal in that site. Therefore, in the Partner conclusion type 1 and 2, the partnership request message should be transmitted to the site manager at the time of or after the ad-distribution. For reference, the meaning of “transmitting a message” in the present disclosure includes both directly sending a message and making the message receiver confirm the message via a link.

It is preferable to notify the site manager of the fact that he or she will get paid the second advertising fee for the price of partner relationship so as to encourage the conclusion of the partner relationship, and it is more preferable to show the actual advertising result that has been occurred for a predetermined period and the second advertising fee to be paid based on the advertising result.

FIG. 6 depicts an example of partnership request message 130 according to the present invention. Referring to FIG. 6, the partnership request message 130 includes an guidance phrase 131 that shows a brief information about the advertising result and the estimated second advertising fee. The present invention allows the distributor member 400 to distribute electronic ads on any site without the permission of the site manager, calculates the advertising result temporarily occurring in the site before the site manager deletes the distributed electronic ads, and then informs the site manager of the estimated second advertising fee to be paid when the partner relationship is made. By this way, it is possible to encourage the conclusion of the partner relationship between the advertisement intermediation site 200 and a site manager.

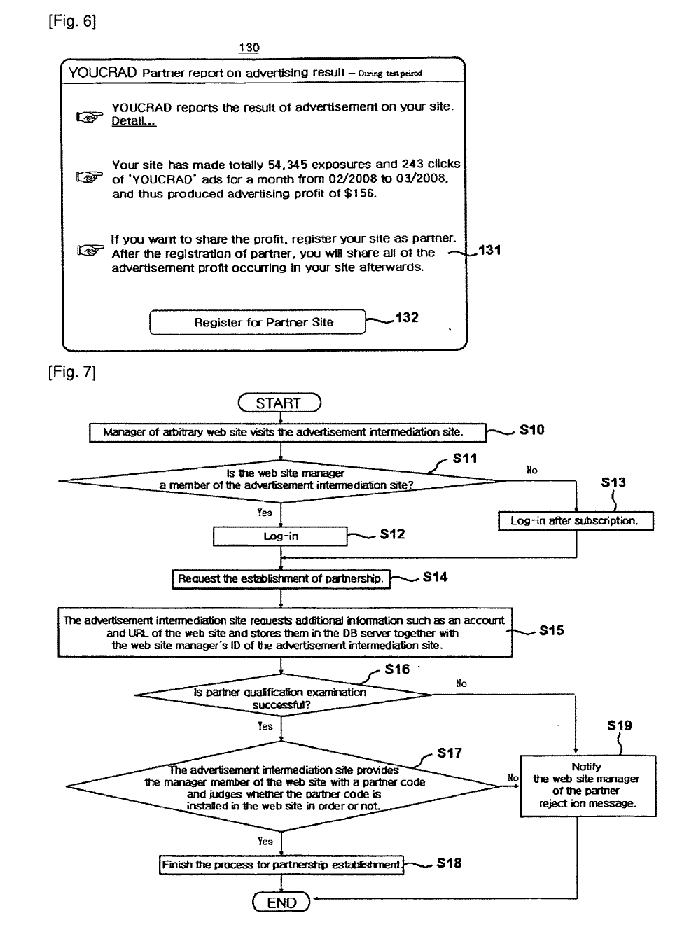

Also, the partnership request message 130 includes a partner conclusion interface 132. When the site manager clicks on the partner conclusion interface 132, the site manager may input the URL of his or her site at the advertisement intermediation site 200 and get a unique identifier given per a partner site. Of course, when the partner conclusion interface 132 is clicked, the site manager needs to subscribe to the advertisement intermediation site 200 as a manager member of a partner site so as to prepare a URL of partner site and open an account wicket for the second advertising fee (refer to FIG. 7).

In the meantime, said Partner conclusion type 3 shows the most general case that a site manager subscribes to the advertisement intermediation site 200 and register his or her site as a partner site and the detailed process for this is depicted in FIG. 7. FIG. 7 is a flow chart that shows a process for making a partner relationship between an advertisement intermediation site 200 and a partner site 300 according to an embodiment of the present invention.

Referring to FIG. 3 and FIG. 7, firstly a manager of a website accesses the web server 210 of the advertisement intermediation site 200 via the internet (step S10), and then the advertisement intermediation site 200 judges whether the website manager is a member of the advertisement intermediation site 200 or not (step S11). If the website manager is a member of the advertisement intermediation site 200 (“YES” in step S11), the process proceeds to step S12 to permit the log-in of the website manager. If the website manager is not a member (“NO” in step S11), the process proceeds to step S13 to make the website manager log-in after subscription.

Next, the website manager requests his or her site to be registered as a partner site of the advertisement intermediation site 200 in the log-in status (step S14), and then the web server 210 of the advertisement intermediation site 200 requests additional information such as account and URL of the website (step S15). Here, the additional information means that the advertisement intermediation site 200 may request more information for the registration of partner site in addition to the basic membership information of the website manager received at step S12 or step S13, and the account information is for managing the settlement history related with the second advertising fee provided by the advertisement intermediation site 200 as a reward for the cooperation of advertisement intermediation activity. For reference, if a website manages multiple URL's, it is possible to receive a partner site request per URL's such as “blog.youcard.com” or “tour.youcrad.com”, and it is also possible to receive a partner site request in the shape of “*.youcrad.com”. When necessary information for the conclusion of partner relationship is secured, the advertisement intermediation site 200 stores manager member's ID and said additional information such as URL and account information together in the DB server 220 (step S15).

Next, the advertisement intermediation site 200 performs partner qualification examination on the website (step S16). The partner qualification examination is for examining whether the partner-requested website is a site that contradicts the advertisement policy of the advertisement intermediation site 200 such as an adult-only site or illegal gambling site and so on. If the website fails this examination (“NO” in step S16), the process proceeds to step S19 to notify the website manager of the partner reject message and terminate the partner conclusion process.

In the meantime, if the website passes the examination (“YES” in step S16), the process proceeds to step S17 to provide the manager member of the website with a partner code that interlocks with the advertisement intermediation script file prepared in the advertisement intermediation site 200 and judge whether the partner code is installed the partner-requested website in order or not. This process is necessary to find out whether the manager member who request partner relationship for the corresponding website is really having a rightful management authority or not. Therefore, the partner code may include an initialization function that automatically report the successful or unsuccessful installation of the partner code into the partner-requested website so as to judge the genuineness of the manager member who requested partner relationship. Here, advertisement intermediation site 200 may judge that the partner code is not in order if the website manager fails to insert the partner code into the source of the website because of no authority, or fails to properly attach the partner code with the source code of the website, or modify the partner code improperly.

If the partner code is not properly installed or deleted in the website (“NO” in step S17), the process proceeds to step S19 to notify the website manager of the partner reject message (or an order message to make the partner code in order) and terminate the partner conclusion process. On the other hand, if the partner code is properly installed in the website (“YES” in step S17), the partner conclusion process will be terminated and the partner-requested website will be finally registered as a partner site 300 (step S18). After step S18 has been done, the manager member of the partner site 300 may get a reward of the second advertising fee according to the advertising result occurred in the partner site 300.

To give an additional comment, it is possible for the advertisement intermediation site 200 to perform the partner qualification examination after providing the partner code although providing the partner code is performed after the partner qualification examination in the above description and FIG. 7.

II3. Effect of Conclusion or Non-Conclusion of Partner Relationship

After a specific website is registered as a partner site 300 according to the above-described processes, the advertisement intermediation site 200 needs to find the total of advertising result per a partner site 300 when it is managing the advertising result. This is for the accounts settlement of the second advertising fee to be paid to the partner site 300 and the second advertising fee is obtained by means of multiplying the total number of clicks occurred in the partner site by CPC to get a sun of advertising cost at the partner site and then multiplying said sum by a fee-rate determined for each partner site to find the final second advertising fee. Besides, it is also possible to differentiate fee-rate relations between sponsors and partner sites and reckon (the number of clicks)*(CPC)*(fee-rate per sponsor) per an electronic ad and then obtain the second advertising fee by summing up said reckoned results for every electronic ads distributed in the partner site. Furthermore, if the partner site includes multiple pages that produce different exposure effectiveness, it may be considered to adopt additional calculating component of “fee-rate per page” in obtaining the second advertising fee and admit different advertising effect per pages even in the same partner site. Of course, although the above-description is made based on the premise that advertising effect can be acknowledged only when the ad is clicked, it may be modified for the case that the advertising effect can be admitted even by a mere exposure without a click.

Also, it is possible to set a limitation for prohibiting the manager or owner of the partner site from deleting the distributed electronic ads at his or her convenience.

In the meantime, several limitations may be applied when a site manager transmits a denial message on the partnership request message to the advertisement intermediation site 200. That is, it is preferable to delete the distributed electronic ads in a lump if a website refuses to be a partner site because the electronic ads distributed through the advertisement intermediation site 200 are still able to increase the traffic amount of the website in a sense. It is also possible to only forbid the distribution step for the website which denied partner relationship. Of course, the website that denied partnership request message 130 will be treated as a general website 800 in view of the advertisement intermediation site 200 and in this case the distributor member 400 may still distribute the electronic ads of the advertisement intermediation site 200 by means of copy-and-paste into the text writing area included in the general website 800.

As is already explained in 111, the biggest change that happens in a website when the website accepts the partner relationship is an ad-interface, but the detailed description for the ad-interface will be given in item III.

III. Distribution of Electronic Ads

The distribution of electronic ads that may occur in the present invention can be divided into the following two types: distribution on general website 800 and distribution on partner site 300.

III1. Distribution on General Website

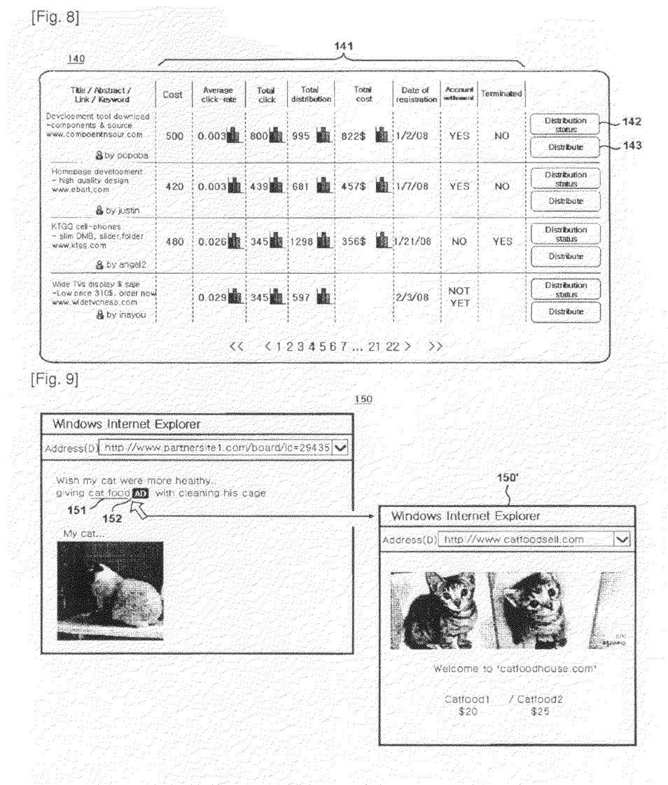

FIG. 8 depicts an example of an interface 140 provided by an advertisement intermediation site 200 for executing distribution step according to the present invention. Referring to FIG. 8, a case of distributing electronic ads on the general website 800 will be explained first.

In reference to FIG. 8, when the distribution occurs in the general website 800, the distributor member 400 may select at least one electronic ad among the ads given in the distribution interface 140 of the advertisement intermediation site 200 using check boxes (not shown) and then click the distribution button 143 after designating the general website 800 in which he or she is going to distribute electronic ads. Here, it should be noted that there should be at least one text writing area in the general website 800 to distribute electronic ads not to the partner site 300 but to the general website 800. And it also should be noted that if a partner site 300 includes a text writing area the distributor member 400 is able to use both the text writing area and ad-interface to distribute electronic ads. As depicted in FIG. 8, there are shown lists of electronic ads including at least one of the title, abstract (or advertising wording), link to be launched and keyword of electronic ads on the left side of the distribution interface 140 provided to the distributor member 400.

If a general website 800 at which the distributor member 400 is going to distribute electronic ads includes a space capable of writing a text, the member of advertisement intermediation site 200 may, for example, directly input or choose the URL of the site where he or she wants to distribute the selected electronic ads so as to launch the target site and then distribute electronic ads by way of pasting and inserting the electronic ad, the identifier of it and the identifier of the distributor member in the text writing area using CTRL+V key.

An important thing at this point is that it is preferable for the web server 210 of the advertisement intermediation site 200 to make an image of copied electronic ad if the electronic ad on clipboard includes text. This is required to remove a possibility for the distributor member 400 to modify the text content of electronic ad copied on clipboard when the advertisement intermediation site 200 provides the distributor member 400 with the electronic ad of text type.

When the advertisement intermediation site 200 intermediates the member's distribution of an ad to the other site, the advertisement intermediation site 200 may trace the present condition of distribution on where the ad is distributed according to an identifier of the ad. By securing the present condition of distribution, it is preferable not to distribute the same ad to the same site repeatedly since the situation that a number of same ads are thoughtlessly distributed on the same site may irritate the website user even though the present invention is aimed to maximize the advertising result by making it easy for unspecific multiple members to distribute electronic ads to arbitrary sites. In this case, the criteria for the “same site” in which the repeated distribution is prohibited may be changed to a domain or a webpage and so on so that the regulation degree of the repeated distribution can be controlled.

In the meantime, when a member distributes electronic ads, the distributed electronic ads may include a reply box in themselves to have reactions on the electronic ads. The reply box is composed of separate space from the reply writing are provided by the website and may be activated when a mouse is on the distributed electronic ads so as to make the general web user 600 who is exposed to the electronic ads get interested in the electronic ads.

In the present invention, the distribution interface 140 provided to the distributor member 400 on the advertisement intermediation site 200 according to the present invention preferably includes an electronic ad information box 141 since the electronic ad is a profit-making tool for the distributor member 400. The electronic ad information box 141 may incorporate the following information: CPC for the electronic ad (please be noted that higher CPC will increase the expectation for profit to be paid to the distributor member 400), average click-rate (that is calculated by dividing the number of total clicks by the number of total exposures), total number of clicks (this is related with the first advertising fee to be paid to the distributor member 400), total distribution number (this is related with the degree of preference of other distributor members on the electronic ad), total cost (that is, an accumulated advertising cost that should be paid by the sponsor 100 according to the distribution of ad), and the date of registration of electronic ad. Moreover, it is more preferable to include more information regarding settlement information on whether an electronic ad has got a formal registration by the payment approval of the sponsor 100 or the electronic ad is provisionally registered by the ad-introducer member 700 and expiration information on whether the period of an electronic ad is terminated or not.

In this way, the distributor member 400 who is going to distribute electronic ads may anticipate which advertisement will give the most first advertising fee and may also feel very interested in the ad-intermediation activity itself since the members of the advertisement intermediation site 200 might think that they are playing a kind of game with calculating gain and loss. Preferably, the electronic ad information box 141 may be comprised of graphical components such as bar graphs as depicted in FIG. 8 and this may improve the visibility of various information about electronic ads. Furthermore, by clicking the present distribution condition button 142 of FIG. 8, the distributor member 400 can know in advance the information regarding where the electronic ads to be distributed are now distributed and how they are making advertising result.

III2. Distribution on Partner Site

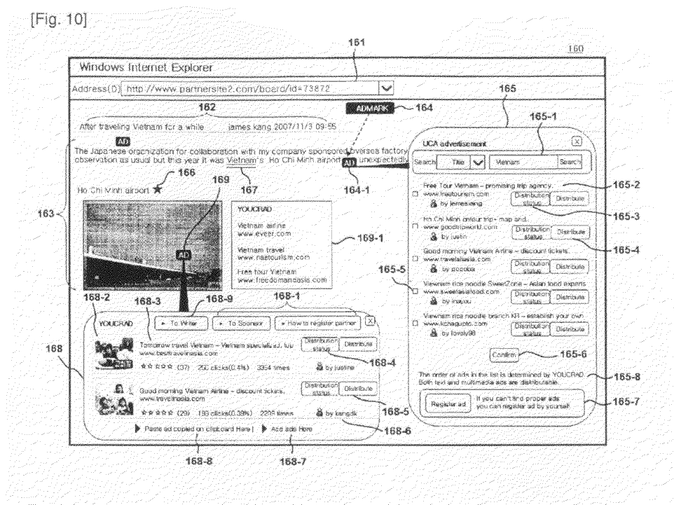

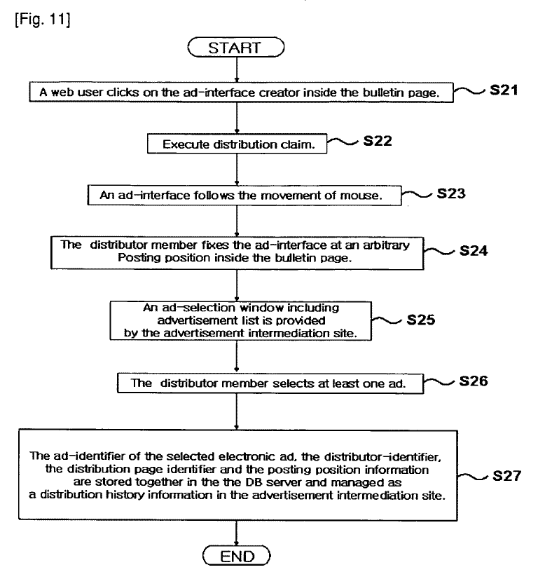

FIG. 9 and FIG. 10 illustrate a case that electronic ads are distributed by using an ad-interface on the webpage of a partner site 300 according to an electronic advertisement method of the present invention, and FIG. 11 is a flow chart that shows a process for distributing electronic ads to distribution page 150, 160 of a partner site 300 according to an electronic advertisement method of the present invention.

At first, referring to FIG. 9 and FIG. 10, the ad-interfaces 152, 164-1, 166, 167, 169 are provided on the distribution page 150, 160 of the partner site 300 in the shapes of image, underline 151, text and so on.

For example, when the distributor member 400 visiting the distribution page 150, 160 of the partner site 300 clicks on the ad-interface creator 164 to create an ad-interface or creates an ad-interface by right-clicking and designates the posting place of the created ad-interface, electronic ads are shown to the distributor member 400 on the ad-selection window 165 of pop-up type interlocking with the ad-interfaces 152, 164-1, 166, 167, 169. Here, the posting place of the ad-interfaces 152, 164-1, 166, 167, 169 can be designated by the distributor member 400 by means of drag-and-drop.

The electronic ads distributed in the shape of ad-interfaces 152, 164-1, 166, 167, 169 on the partner site 300 are shown to web users in the form of single body incorporating with the written text. When the general web user 600 visiting the partner site 300 moves the mouse on the highlighted or underlined ad-interface or image-type ad-interface that indicates there is attached an ad, the electronic ads matched with the ad-interface are immediately provided in a form of pop-up window, or the website 150′ according to the electronic ad is automatically launched.

In this way, the immediate interlocking interface may facilitate the distribution of electronic ads and achieve a high degree of contextual advertisement that cannot be expected in the prior art since the electronic ads is able to be posted on the exact positions related with the ads among the body substance of a bulletin.

In the meantime, the distributor member 400 is able to make one ad-interface interlock with a plurality of electronic ads.

Now, explanations on the distribution process of electronic ads according to the present invention will be given referring to FIG. 3, FIG. 9, FIG. 10 and FIG. 11.

First, when a web user visits a partner site 300, the web user is provided with the distribution pages 150, 160 and may use the ad-interface creator 164 or operate the mouse such as right-click so as to create an ad-interface (step S21). Here, when the web user clicks on the ad-interface creator 164, the partner code activated in the terminal of the web user will execute the distribution claim (hereinafter, “first claim”) that makes the web user log-in to the advertisement intermediation site 200 for claiming the web user's ad-distribution activity and secure the distributor member 400 ID of the web user (step S22).

After step S22 is finished, the ad-interfaces 152, 164-1, 166, 167, 169 of FIG. 9 and FIG. 10 follows the distributor member 400's mouse so that they can be posted anywhere of the distribution page 150, 160, and the ad-interfaces 152, 164-1, 166, 167, 169 will be fixed at the posting place designated by the distributor member 400 when the distributor member 400 founds a proper position for distribution among the body substance of a bulletin (step S24). Here, the ad-interfaces 152, 164-1, 166, 167, 169 are inserted in the body substance 163 of the distribution pages 150, 160, and the inserting operation may be performed by inserting an image of “AD” between letters of the body substance or overlapping an image of “AD” on a picture included in the body substance.

In addition, like 169-1 of FIG. 10, it is also possible to place the electronic ads utilizing the empty space beside the picture of the body substance of the distribution pages 150, 160. The distribution type such as reference numeral 169-1 is a case that the electronic ad itself includes a brief summary of advertisement directly shown to the network user.

Moreover, when the posting place of the ad-interface is determined, the script of the advertisement intermediation site 200 acquires information regarding the posting place (for example, coordinate value on the screen) in which the ad-interface is installed on the distribution pages 150, 160 so that the ad-interfaces 152, 164-1, 166, 167, 169 can be always positioned at the right position intended by the distributor member 400 whenever the distribution page 150, 160 is loaded by the general web user 600. In regard to this, it is preferable for the advertisement intermediation site 200 to scan the body substance of the distribution page 150, 160 and search areas between letters or areas that do not have any texts or pictures so as to find a relative position that the posting place of the ad-interfaces 152, 164, 166, 167, 169 have inside the body substance. By this way, it is possible show the ad-interfaces 152, 164-1, 166, 167, 169 on the exact position intended by the distributor member 400 among the body substance regardless of size or resolution of the web browser used by the web user visiting the distribution page 150, 160.

When the ad-interfaces 152, 164-1, 166, 167, 169 are fixed on a specific position by double-click or right-click of mouse, the terminal of the distributor member 400 is provided with a ad-selection window 165 transmitted from the advertisement intermediation site 200 (step S25), and the distributor member 400 may, for example, input the search word “Vietnam” in the searching box 165-1 in accordance with the body substance about “Ho Chi Minh in Vietnam” so as to search electronic ads related with Vietnam.

Afterwards, the distributor member 400 may look over brief ad-content 165-2 together with the actual number of distribution to other sites or the distribution status 165-3 about the searched electronic ads, and then select at least one electronic ad that will interlock with the fixed ad-interfaces 152, 164-1, 166, 167, 169 by clicking the distribution button 165-4 or clicking both the check box 165-5 and confirmation button 165-6 (step S26).

When the distributor member 400 completes the selection of posting place of ad-interfaces 152, 164-1, 166, 167, 169 and at least one ad, the process proceeds to step S27 to store the identifier of the selected electronic ad, the posting place of ad-interfaces 152, 164-1, 166, 167, 169, ID of the distribution page 150, 160 where the electronic ad is distributed, distributor member 400 ID of the advertisement intermediation site together in the DB server 220 of the advertisement intermediation site 200, and manages this as distribution history information (step S27). For reference, the ID of the distribution page 160, 160 is an identifier that the advertisement intermediation site 200 itself creates and manages for the purpose of differentiating the distribution pages 150, 160. If the partner site 300 gives different URL's per distribution pages that include bulletins, this URL 161 information can be used to create the ID of the distribution pages 150, 160. In addition, if the partner site 300 does not give different URL's per different distribution pages, the advertisement intermediation site 200 needs to analyze the property of the distribution pages 150, 160 for the purpose of differentiating the distribution pages. In case of FIG. 10, the distribution page 160 has a bulletin properties 162 comprising bulletin title, writing time and writer's nickname, and thus the advertisement intermediation site 200 may create an identifier for the distribution page 160 based on this property information 162.

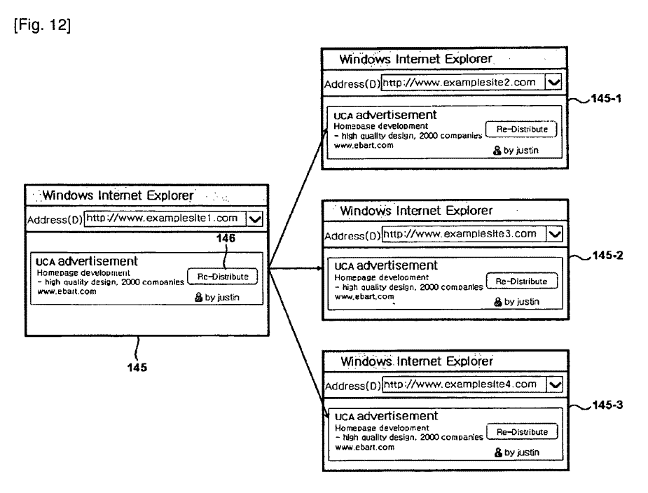

Next, FIG. 12 illustrates how to execute a re-distribution interface 146 according to an embodiment of the present invention. Referring to FIG. 12, the distribution page 145 where the electronic ad is distributed contains electronic ads together with a re-distribution interface 146 of button type. Therefore, a general web user 600 who visited the first distribution page 145 is also able to copy the electronic ads, identifiers of the copied electronic ads and identifier of the re-distributor member on clipboard with the support of the advertisement intermediation site 200 by clicking this re-distribution interface 146, and then paste the copied electronic ads to a page designated by the re-distributor member among the pages of other sites 145-1, 145-2, 145-3 so as to execute the re-distribution step. At this point, it should be noted that the general web user 600 who wants to execute the re-distribution step needs to perform the access process (that is, the first claim process) toward the advertisement intermediation site 200 as a distributor member 400 to take the support of the re-distribution step from the advertisement intermediation site 200. After the re-distribution of electronic ad is executed, the management step for the re-distributed electronic ad will be the same with that for the case of general distribution. That is, the re-distributor member will take a reward based on the first advertising fee calculated by summing up the advertising result of the re-distributed ad per re-distributor members using the identifier of the re-distributor member. Here, the fee rate for the first advertising fee of the re-distributor member may be adjusted to consider the balance with the fee rate of original distributor member.

IV. Securing of Electronic Bulletin

If a website is registered as a partner site 300 of the advertisement intermediation site 200, the writer member 500 is able to write an electronic bulletin in the partner site 300. Of course, it might be possible to write an electronic bulletin such as a text or a blog in the website even before the website becomes a partner site, but if the website is registered as a partner site 300, it is possible to execute the process for the bulletin writer claiming his or her writing activity in the partner site 300 toward the advertisement intermediation site 200, which is called bulletin writing claim.

The bulletin writing claim may include not only a case that the writer member 500 logged-in the advertisement intermediation site 200 writes the bulletin in the partner site 300 as indicated by a solid line in FIG. 3, but also a case that a general web user writes a bulletin first and then logsin the advertisement intermediation site 200 by the bulletin writing claim function executed on the partner site 300 so as to report his or her bulletin.

In addition, the bulletin writing claim does not have to be executed at the time of writing bulletins, but may be performed to the electronic bulletins already written. It is also possible to make every afterwards bulletin automatically go through the bulletin writing claim. Of cause, if the partner site 300 provides the advertisement intermediation site 200 with its membership information, it would be easier to execute the bulletin writing claim.

The present invention encourages the bulleting writing in the partner site 300 for advertising as many ads that correspond to the visiting purpose of the general web user 600 visiting websites as possible. Here, it should be noted that the writing member 500 is not related with the distributor member 400 at all, but a web user who is basically functioning as a member of the partner site 300. That is, in the present invention, a person who writes an electronic bulletin on the partner site 300 is encouraged to notify the advertisement intermediation site 200 of his or her bulleting writing activity and thereby able to take a reward of third advertising fee for providing bulletins where the electronic ads are distributed although the person did not participate in advertising directly. In this way, it is possible to improve the effectiveness of ad-distribution by explicitly differentiating the roles of writer member 500 and distributor member 400, and at the same time it is also possible to revitalize the distribution of electronic ads with securing a lot of bulletins with good quality.

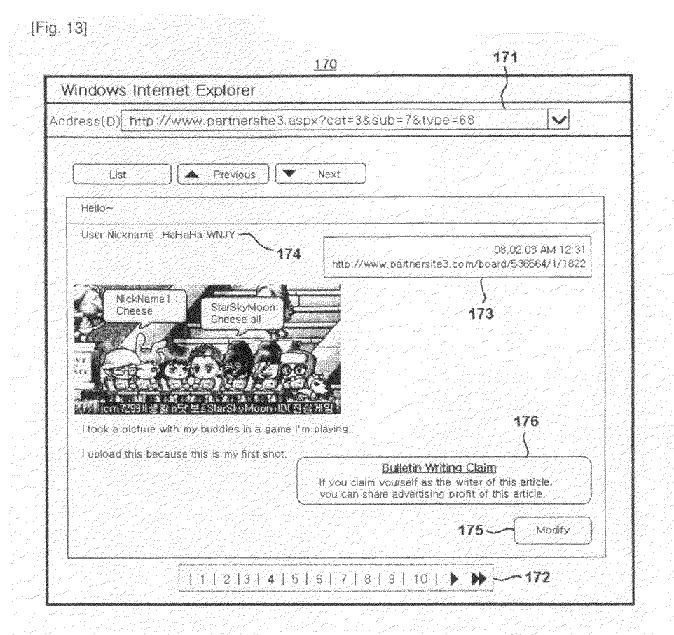

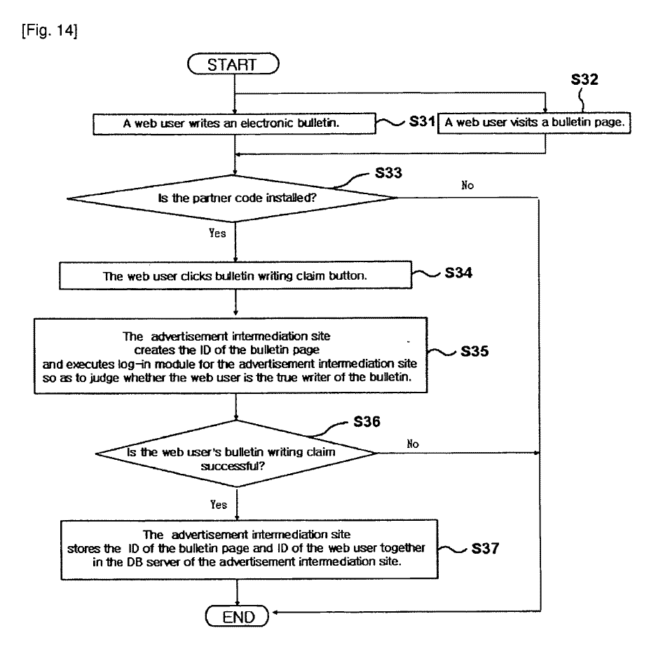

Now the bulletin securing process of electronic ads according to the present invention will be explained in detail. FIG. 13 depicts an example of a bulletin page 170 written in a partner site 300, and FIG. 14 is a flow chart to illustrate how an electronic bulletin 170 written on the webpage of a partner site 300 is claimed (that is, second claim) according to an embodiment of the present invention.

Referring to FIG. 3, FIG. 13 and FIG. 14, the web user accesses the web ser 310 of the partner site 300 and writes an electronic bulletin 170 (step S31) or visits the bulletin page 170 written by himself or herself in the partner site 300 (step S32). In this case, the web server 310 of the partner site 300 provides the webpage requested by the web user together and at the same time the partner code of <.JS> type as described above is transmitted to the terminal of the web user. Thus, if the bulletin page written by the web user is not the page of the partner site 300, the result of step S33 will be “NO” since there is no partner code installed in that bulletin. If the partner code is installed in the bulletin, the result of step S33 will be “YES” and the process for the bulletin writing claim will be continued.

Next, when the web user visiting the bulletin page 170 of the partner site 300 clicks the bulletin writing claim button 176 so as to activate the second claim function (step S34), the script of the advertisement intermediation site 200 creates the ID of the bulletin page 170 and executes log-in module to the advertisement intermediation site 200 so as to judge whether the web user who clicked the bulletin writing claim button 176 is the true writer of that bulletin (step S35).

Here, the ID (that may be also called article ID) of the bulletin page 170 is a bulletin identifier that is created by the advertisement intermediation site 200 in itself based on the analysis of the properties of the bulletin page 170. That is, if the partner site 300 gives its own unique URL 171 to the bulletin page 170 as depicted in FIG. 6, this URL 171 may be used as the ID of the bulletin page. However, for example, if the partner site 300 does not give different URL's by adopting paging buttons 172, the advertisement intermediation site 200 will judge that it is impossible to identify the bulletin page based on URL information after scanning the bulletin page 170, and in this case the advertisement intermediation site 200 needs to analyze various components or properties included in the bulletin page 170 so as to create the identifier of the bulletin page. In case of FIG. 13, since the partner site 300 exposes not only URL 171 but also a unique number 173 that can be used to access to the present bulletin, this unique number 173 may be utilized to create the ID of the bulletin page.

In the meantime, the method for judging whether the web user who clicks the bulletin writing claim button 176 and tries to the second claim is the true writer of the present bulletin page 170 or not may be, for example, a method in which the script of the advertisement intermediation site 200 automatically execute the process of going through the amendment of the webpage 170. This method is using the point that only the person who had written the bulletin has the bulletin amendment authority in most sites that allows bulletin writing. Therefore, for example, it is possible to find out whether a web user who is executing the second claim is a true writer or not by using the amendment function included in the amendment button 175 of the bulletin page 170 and checking the web user's amendment authority.

If the web user executing the second claim is acknowledged as the true writer of the bulletin page 170 through said processes (“YES” in step S36), the advertisement intermediation site 200 records the unique page ID given to the bulletin page 170 and ID of the bulletin writer (that is, the advertisement intermediation site 200 ID of the web user who succeeded in the second claim) together in the DB server 220 of the advertisement intermediation site WO so as to provide the web user with the third advertising fee by acknowledging the web user as the writer member 500 based on the advertising result occurring in the bulletin page 170 afterwards (step S37). Of course, if the web user performing step S35 is proven to be a false writer of the bulletin (“NO” in step S36), the bulletin writing claim process will be terminated.

For reference, when the web user executing the second claim is acknowledged as a true writer of the bulletin according to the present invention, the following method may be used for the advertisement intermediation site 200 to automatically acknowledge the successful second claim to every bulletin that is written or will be written afterwards in the partner site 300 by the web user who once succeeded in the second claim. The method is to analyze the structure of the webpage 170 by the function of the advertisement intermediation site 200 that executes the second claim. For example, if a specific partner site 300 registered on the advertisement intermediation site 200 adopts a policy to expose the ID (that is, the partner site ID, not the advertisement intermediation site ID) of the bulletin writer inside the webpage where a bulletin is written, it would be possible to scan the portion of the webpage that contains the ID by the claim script file and match the scanned ID with the writer member 500 ID who has ever succeeded in the second claim before. For instance, since there is exposed a nickname 174 of a writer member X who has writer member ID “WNJY” which is proven to be succeeded in the second claim for the bulletin page 170, the advertisement intermediation site 200 may automatically acknowledge that the writer member 500 X (ID: “WNJY”) of the advertisement intermediation site 200 is true writer of other bulletins that are written on the web pages of the partner site 300 by “HaHaHa WNJY” based on the partner site nickname information 174.

V. Reading of Electronic Ads and Management of Advertising Result

After the electronic ads are distributed on the distribution page 150, 160 of the partner site 300 by the distributor member 400, the general web user 600 visiting the distribution page 150, 160 may read the ads through the ad-interfaces 152, 164-1, 166, 167, 169 included in the body substance.

That is, as depicted in FIG. 10, when a general web user 600 takes an action such as on-mouse or click on the ad-interfaces of the webpage 160 where electronic ads are distributed, there is provided an ad-window 168 of pop-up type including both the electronic ads 168-2 and the distributor ID information 168-6 linked with the ad-interface 169. The ad-window 168 provides a brief explanation of the electronic ad 168-3 and so-far status of distribution 168-4 about each ad. Preferably, the ad-window 168 may include a message 168-1 that explains or advertises the advertisement intermediation site 200. It is also preferable to install a bulletin writing claim button 168-9 in the ad-window 168 for the writer member 500 who wrote the body substance of the distribution page 160 to execute the bulletin writing claim (the second claim).

Moreover, the general web user 600 reading the ads may click the distribution button 168-5 of the ad-window 168, execute the first claim, and then distribute the electronic ads to some other desirable position inside the body substance 163. Also, the general web user 600 may click the ad-adding button 168-7 in the ad-window 168 to bring the ad-selection window 165 and execute the first claim for the distribution of electronic ads. Furthermore, the distributor member 400 who is in session of log-in to the advertisement intermediation site 200 may select and copy an ad on the clipboard from the advertisement intermediation site 200 by using CTRL+C key to fetch and paste it to the ad-window 168 by using the ad-paste button 168-8. The above-mentioned methods are ways to distribute electronic ads by means of adding electronic ads to the ad-window 168.

Continuously referring to FIG. 10, the partner code activated in the distribution page 160 executes a function that transmits the history of general web user 600's activities to the advertisement intermediation site 200 and in this way the advertisement intermediation site 200 detects the occurrence of the advertising result in the distribution page 150, 160, records the amount of fees reflecting the advertising result according to the “exposure” per the identifier of the exposed electronic ad 168-2 through the ad-window 168 and ID's of the sponsor 100, the distributor member 400 who distributed the electronic ad 168-2, the writer member 500 of the distribution page 160 where the electronic ad 168-2 is exposed and manager member of the partner site 300, and increases the number of ad-exposure and stores the increased number to the DB server 220.

If the general web user 600 who opened the ad-window 168 at the distribution page 160 moves to the sponsor's page by clicking the electronic ad, the advertisement intermediation site 200 records the amount of fees reflecting the advertising result according to the “click” per the identifier of the clicked electronic ad 168-2 and ID's of the sponsor 100, the distributor member 400 who distributed the electronic ad 168-2, the writer member 500 of the distribution page 160 where the electronic ad 168-2 is clicked and manager member of the partner site 300, and increases the number of ad-click and stores the increased number to the DB server 220.

Here, the advertising result in the present invention may include the exposure number and the click number (of course, the present invention is not limited to this). That is, exposing the electronic ad to a general web user 600 on other site may not be enough for the sponsor 100 to acknowledge the advertising outcome of electronic ads that he or she paid advertising cost for the registration on the advertisement intermediation site 200. Instead, the sponsor 100 may acknowledge the occurrence of the advertising result only when the general web user 600 visiting other sites clicks the sponsor 100's ad to recognize the content of the ad. Of course, the number of exposure may be still the advertising result. The number of exposure shows how many internet users visit the site where the electronic ad is distributed, and thus the advertisement intermediation site 200 is able to grasp the number of exposure by monitoring the traffic of the site where the electronic ad is distributed.

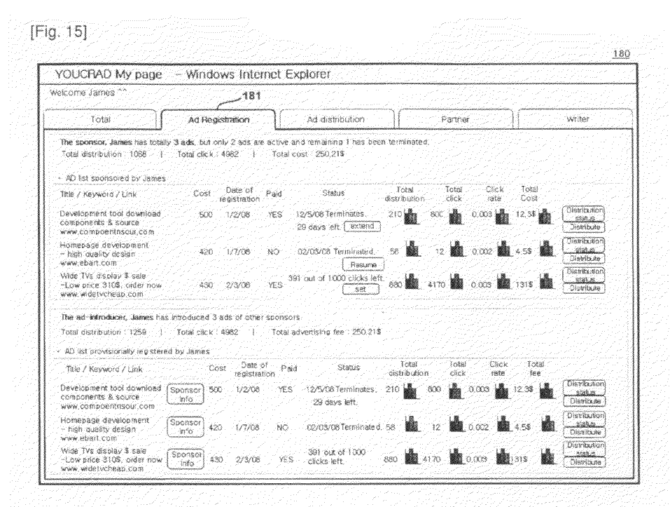

Since a member of the advertisement intermediation site 200 may participate in electronic advertising with performing multiple roles such as distributor member, manager member of partner site, writer member and ad-introducer member in the present invention, it is preferable to provide a unified management interface 180 that shows the distribution status of the electronic ad at a glance as depicted in FIG. 15. For reference, FIG. 15 exemplifies the management tap 181 for the ad-introducer member among the management taps of the unified management interface 180.

So far preferable embodiments of the present invention have been provided, but the technical idea of the present invention is not limited to above-described embodiment. For example, although the above-described embodiment is related to the advertisement intermediation method for the advertisement intermediation site on the internet, the electronic advertisement method provided in the present invention may be applied to any kind of network environment including wireless mobile communication. In this case, SMS server may be systematically needed.

Moreover, the concept of the first advertising fee and the second advertising fee according to the present invention may be utilized to the multi-level ad-intermediation. That is, for example, if a partner site is a portal site, the general interne user who is visiting the portal site and distributing electronic ads will be provided with the first advertising fee and the manager of the portal site will be provided with the second advertising fee. However, since the distribution of electronic ads to the blog or mini-homepage is possible when the portal site provides blogs or mini-homepages, in this case the owner of the blog or mini-homepage will be rewarded with the second advertising fee and the distributor who distributed electronic ads to the blog or mini-homepage will be rewarded with the first advertising fee. Therefore, according to the present invention, multi-level ad-intermediation chain comprised of “portal site manager owner of blog or mini-homepage distributor member” may be possible. In this case, the manager of the portal site will be paid based on the summed amount of money applied with different advertisement charge rate according to whether the electronic ad is distributed in the portal site or blog/mini-homepage provided by the portal site.

In addition, it should be noted that the amount of said first to fourth advertising fee can be varied according to not only the criteria for judging the advertising result but also the policy determined by the sponsor 100 or advertisement intermediation site 200. Exemplifying for the purpose of detailed description, if the sponsor 100 removed the possibility of paying the fourth advertising fee by voluntarily introducing his or her electronic ad, the sponsor 100 may have a margin to request the discount of advertising cost to be paid to the advertisement intermediation site 200. For instance, when assuming that the first, second and fourth advertising fee is determined by the 10% of advertising cost per a click, if the ad-introducer member 700 introduced the electronic ad before the sponsor 100's registration, 7,000Won of 10,000Won will be taken by the advertisement intermediation site 200 and 1,000Won of the remaining 3,000Won will be distributed to the distributor member 400, manager member of partner site 300 and ad-introducer member 700, respectively. Thus, when the sponsor 100 voluntarily registered its electronic ad and removed the payment factor of 1,000Won for the fourth advertising fee, the sponsor 100 may request the fee-rate of the first and second advertising fee to be raised to 15% so as to revitalize the distribution of electronic ad toward the advertisement intermediation site 200, or may request the advertisement intermediation site 200 to reduce the advertising cost to 9,000Won and maintain the first and second advertising fee with 1,000Won. By this way, the present invention may indirectly encourage the sponsor 100 to voluntarily register its electronic ad. Besides, for example, the timing when the ID of distribution page and ID of bulletin page are generated may be freely adjusted before or after the distribution claim or bulletin writing claim is completed in FIG. 7 or FIG. 14.

In this way, it shall be understood that all modifications and embodiments conceived from the meaning and scope of the claims and their equivalents are included in the scope of the present invention in view of a person skilled in the art.

### INDUSTRIAL APPLICABILITY

According to the present invention, anybody using the network environment regardless of owning a site can distribute electronic ads to arbitrary sites that allow the text writing so as to positively participate in advertising and take a reward for the distribution activity. Furthermore, since the advertising is made in a single body with the bulletin of other site, the electronic ads of the present invention may be thought as a part of the bulletin rather than a separate advertisement and thus reduce the rejection reaction on the electronic ads. In addition, since the first advertising fee for the distributor member is increased as the advertising result gets better, if at all possible, the distributor member may be encouraged to distribute the electronic ad to a bulletin which is closely related with the ad, and this in turn will help the electronic ad becoming more useful information to the users reading the bulletin.

Also, the present invention adopts the concept of the partner site and ad-interface to implement a platform that can greatly facilitate the ad-distribution via the advertisement intermediation site and achieve contextual advertisement at the same time. The present invention also provides a tool by which the sponsor member, the distributor member, the ad-introducer member and the manager member of partner site in the advertisement intermediation site can manage the distribution status and advertising result of electronic ads in an organized and unified way so that the electronic advertising industry may be revitalized.

1. An electronic advertisement method using an advertisement intermediation site, comprising:
registering an electronic ad of a sponsor with an adidentifier of the electronic ad on the advertisement intermediation site;
distributing the registered electronic ad to a text writing area of other site with attaching a distributoridentifier when a distributor member distributes the registered electronic ad to said other site including at least one text writing area;
monitoring distribution status, exposure number and click number of the distributed electronic ad using the adidentifier and the distributoridentifier so as to calculate an advertising result; and
rewarding the distributor member with a portion of an advertising cost paid by the sponsor as a first advertising fee based on the advertising result of the distributor member.

2. An electronic advertisement method using an advertisement intermediation site, comprising:
registering an electronic ad of a sponsor with an adidentifier of the electronic ad on the advertisement intermediation site;
receiving a request from a manager member who manages a site to make the site a partner site and establishing a partnership with the site of the manager member with installing an ad-interface in the partner site;
distributing the registered electronic ad to the partner site with attaching a distributoridentifier when a distributor member distributes the registered electronic ad to the partner site through the ad-interface;
monitoring distribution status, exposure number and click number of the distributed electronic ad using the adidentifier and the distributoridentifier so as to calculate an advertising result; and
rewarding the partner site with a portion of an advertising cost paid by the sponsor as a second advertising fee based on the advertising result at the partner site.

3. An electronic advertisement method using an advertisement intermediation site, comprising:
registering an electronic ad of a sponsor with an adidentifier of the electronic ad on the advertisement intermediation site;
distributing the registered electronic ad to other site with attaching a distributoridentifier when a distributor member distributes the registered electronic ad to said other site;
monitoring distribution status, exposure number and click number of the distributed electronic ad using the adidentifier and the distributoridentifier so as to calculate an advertising result;
transmitting a partnership request message with the advertising result to a manager of said other site and making said other site a partner site with installing an adinterface that enables the distributing in the partner site; and
rewarding the partner site with a portion of an advertising cost paid by the sponsor as a second advertising fee based on the advertising result at the partner site.

4. An electronic advertisement method using an advertisement intermediation site that manages a database of an electronic ad of a sponsor together with an adidentifier of the electronic ad and interlocks with at least one partner site providing a distribution page where the electronic ad is distributed, comprising:
providing an adinterface that can be placed anywhere of the distribution page by a distributor member who visits the partner site and is going to distribute the electronic ad to the partner site as a member of the advertisement intermediation site;
providing the electronic ad of the database for selection of the distributor member when the distributor member designates a posting position of the adinterface and securing a distribution history information including the adidentifier of the distributed electronic ad, distributoridentifier, distribution page identifier and posting position information when the distributor member selects the electronic ad that will be loaded through the adinterface;
monitoring distribution status, exposure number and click number of the electronic ad distributed through the adinterface based on the distribution history information so as to calculate an advertising result; and
rewarding the distributor member with a portion of an advertising cost paid by the sponsor as a first advertising fee based on the advertising result.

5. An electronic advertisement method using an advertisement intermediation site that manages a database of an electronic ad of a sponsor together with an adidentifier of the electronic ad and interlocks with at least one partner site providing a distribution page where the electronic ad is distributed, comprising:
Securing a bulletin of the partner site, a writeridentifier of a writer member who writes the bulletin in the partner site as a member of the advertisement intermediation site, and a bulletin page identifier of the bulletin;
providing an adinterface that can be placed anywhere of the bulletin page by a distributor member who visits the distribution page and is going to distribute the electronic ad as a member of the advertisement intermediation site;
providing the electronic ad of the database for selection of the distributor member when the distributor member designates a posting position of the adinterface and securing a distribution history information including the adidentifier of the distributed electronic ad, distributoridentifier, writeridentifier, distribution page identifier and posting position information when the distributor member selects the electronic ad that will be loaded through the adinterface;
monitoring distribution status, exposure number and click number of the electronic ad distributed through the adinterface based on the distribution history information so as to calculate an advertising result; and
rewarding the writer member with a portion of an advertising cost paid by the sponsor as a third advertising fee based on the advertising result.

6. An electronic advertisement method using an advertisement intermediation site, comprising:
provisionally registering an electronic ad of a sponsor introduced by an adintroducer member with an adidentifier of the electronic ad and an adintroduceridentifier and displaying the electronic ad on the advertisement intermediation site;
distributing the provisionally registered electronic ad to other site with attaching a distributoridentifier when a distributor member distributes the provisionally registered electronic ad to said other site;
monitoring distribution status, exposure number and click number of the distributed electronic ad using the adidentifier and the distributoridentifier so as to calculate an advertising result;
transmitting a formal registration request message to the sponsor of the provisionally registered electronic ad and formally registering the provisionally registered electronic ad on condition of the sponsor paying advertising cost when the sponsor consents to the formal registration request message; and
rewarding the adintroducer member with a portion of the advertising cost as a fourth advertising fee based on the advertising result of the adintroducer member.

7. An electronic advertisement method using an advertisement intermediation site, comprising:
randomly or selectively extracting an electronic ad existing in an arbitrary site, automatically and provisionally registering the electronic ad with an adidentifier of the electronic ad, and displaying the electronic ad on the advertisement intermediation site;
distributing the provisionally registered electronic ad to other site with attaching a distributoridentifier when a distributor member distributes the provisionally registered electronic ad to said other site;
monitoring distribution status, exposure number and click number of the distributed electronic ad using the adidentifier and the distributoridentifier so as to calculate an advertising result; and
transmitting a formal registration request message to a sponsor of the provisionally registered electronic ad and formally registering the provisionally registered electronic ad on condition of the sponsor paying advertising cost when the sponsor consents to the formal registration request message.

8. The electronic advertisement method of claim 2, the adinterface is provided in a shape of advertisement mark that notifies the existence of the distributed electronic ad inside body substance of the distribution page of the partner site, wherein the advertisement mark is comprised of at least one of text, underline or image.

9. The electronic advertisement method of claim 4,
the distribution page identifier of the distribution history information is a URL of the distribution page or an ID of the distribution page, which is created by page property, wherein the page property is acquired by the advertisement intermediation site scanning components of the distribution page.

10. The electronic advertisement method of claim 4, the relative position between the adinterface and the body substance of the distribution page is uniformly maintained regardless of the structure, size and resolution of network browser used by network user visiting the distribution page based on the posting position information.

11. The electronic advertisement method of claim 1, further comprising:
performing a first claim that reports the activity of distributing the electronic ad before the distributing is completed when nonmember or nonlogin member of the advertisement intermediation site is trying to distribute the electronic ad.

12. The electronic advertisement method of claim 5, wherein the securing the bulletin of the partner site includes performing a second claim that reports the activity of writing the bulletin in the partner site when nonmember or nonlogin member of the advertisement intermediation site writes the bulletin page.

13. The electronic advertisement method of claim 12, wherein the securing the bulletin of the partner site includes judging whether a network user has a rightful authority to amend the bulletin page when the network user is trying to perform the second claim so as to identify whether the network user is a true writer of the bulletin or not.

14. The electronic advertisement method of claim 12, wherein the securing the bulletin of the partner site includes:
acquiring a property of the bulletin page by scanning components of the bulletin page; analyzing writer property information that enables the identification of the writer of the bulletin page among the acquired property of the bulletin page; and executing the second claim automatically for the bulletin page that has a property corresponding with the analyzed writer property information in the partner site.

15. The electronic advertisement method of claim 6, the formally registering the provisionally registered electronic ad includes:
Setting a limitation not to prohibit at least one of the securing, distributing and managing or deleting the distributed electronic ad in a lump when the formal registration request message is denied by the sponsor, and
wherein the fourth advertising fee is not provided to the adintroducer member and the charge rate for the fourth advertising fee is increased.

16. The electronic advertisement method of claim 6, further comprising:
rewarding the distributor member with a portion of an advertising cost paid by the sponsor as a first advertising fee based on the advertising result of the distributor member when the sponsor consents to the formal registration request message, and
wherein the fourth advertising fee is not provided to the adintroducer member when the sponsor denied the formal registration request message, and the afterwards charge rate of the first advertising fee that will be increased for the distributor member who distributed the denied provisionally registered electronic ad or the adintroducer member who introduced the denied provisionally registered electronic ad.

17. The electronic advertisement method of claim 2, further comprising:
rewarding the distributor member with a portion of an advertising cost paid by the sponsor as a first advertising fee based on the advertising result of the distributor member.

18. The electronic advertisement method of claim 4, further comprising:
rewarding the partner site with a portion of an advertising cost paid by the sponsor as a second advertising fee based on the advertising result at the partner site.

19. The electronic advertisement method of claim 1, wherein a member of the advertisement intermediation site is provided with a management interface that enables the management of the distribution status of the electronic ad.

20. The electronic advertisement method of claim 1, wherein the distributed electronic ad includes a reply area that allows a reply on the distributed electronic ad.

21. The electronic advertisement method of claim 1, wherein the distributed electronic ad includes a redistribution interface that enables additional distribution of the distributed electronic ad to another site,
further comprising:
redistributing the distributed electronic ad to said another site using the redistribution interface by the distributor member of the advertisement intermediation site, and the distributor member includes a member who redistributed the electronic ad.

22. The electronic advertisement method of claim 1,
the electronic ad is made by a admaking tool provided by the advertisement intermediation site.

23. The electronic advertisement method of claim 1,
The distributing of the electronic ad is performed on an electronic map that reflects a geographical information of the electronic ad.

24. The electronic advertisement method of claim 1,
the distributing of the electronic ad is performed by means of copyandpaste with copying the electronic ad from a server of the advertisement intermediation site on clipboard and pasting it to said other site, and
wherein a text included in the electronic ad copied on the clipboard is made into an image by the server of the advertisement intermediation site.

25. An electronic advertisement system using an advertisement intermediation site that includes a main server for providing network site, a database server for managing an electronic ad of a sponsor together with an adidentifier of the electronic ad and a settlement server and interlocks with at least one partner site having an installation of a partner code and providing a distribution page where the electronic ad is distributed, wherein
the partner code calls and executes an advertisement intermediation script of the advertisement intermediation site on a terminal of network user visiting the partner site. And
the advertisement intermediation script comprising:
Securing a bulletin of the partner site, a writeridentifier of a writer member who writes the bulletin in the partner site as a member of the advertisement intermediation site, and a bulletin page identifier of the bulletin;
providing an adinterface that can be placed anywhere of the bulletin page by a distributor member who visits the distribution page and is going to distribute the electronic ad as a member of the advertisement intermediation site;
providing the electronic ad of the database for selection of the distributor member when the distributor member designates a posting position of the adinterface and securing a distribution history information including the adidentifier of the distributed electronic ad, distributoridentifier, writeridentifier, distribution page identifier and posting position information when the distributor member selects the electronic ad that will be loaded through the adinterface;
monitoring distribution status, exposure number and click number of the electronic ad distributed through the adinterface based on the distribution history information so as to calculate an advertising result; and
rewarding the distributor member, the partner site and the writer member with a portion of an advertising cost paid by the sponsor as a first, second and third advertising fee based on the advertising result, respectively.

26. The electronic advertisement method of claim 25,
the advertisement intermediation site acquires an adintroduceridentifier of an adintroducer member of the advertisement intermediation site who provisionally registers the electronic ad on the advertisement intermediation site together with the adidentifier of the provisionally registered electronic ad, and
the advertisement intermediation script performs providing the adinterface, distribution and management of the provisionally registered electronic ad,
and the advertisement intermediation site transmits a formal registration request message to a sponsor of the provisionally registered electronic ad and formally registering the provisionally registered electronic ad on condition of the sponsor paying advertising cost when the sponsor consents to the formal registration request message.

27. The electronic advertisement method of claim 25,
wherein the advertisement intermediation script performs a partner judgment process for judging whether the partner code is normally executed in the partner site.
